(19) United States
(12) Patent Application Publication
(10) Pub. No.: US 2016/0255639 A1
(43) Pub. Date: Sep. 1, 2016

(54) INTERFERENCE MITIGATION IN A WIRELESS COMMUNICATION SYSTEM

(71) Applicant: QUALCOMM Incorporated, San Diego, CA (US)

(72) Inventors: Qingxin CHEN, San Diego, CA (US); Minkui LIU, San Diego, CA (US); Francis Ming-Meng NGAI, San Diego, CA (US); Shanshan WANG, San Diego, CA (US); Chinmway S. VAZE, San Diego, CA (US); Insung KANG, San Diego, CA (US); Tom CHIN, San Diego, CA (US); Wei ZHANG, San Diego, CA (US); Zhibin DANG, San Diego, CA (US); Xiaoning LU, San Diego, CA (US); Abhijit YESHWANTPUR, San Diego, CA (US); Baris EFE, San Diego, CA (US); Michael Lee MCCLOUD, San Diego, CA (US)

(21) Appl. No.: 15/031,220

(22) PCT Filed: Nov. 20, 2014
(86) PCT No.: PCT/CN2014/091771

§ 371 Date: Apr. 21, 2016

(30) Foreign Application Priority Data
Nov. 29, 2013 (CN) PCT/CN2013/088121

(51) Int. Cl. H04W 72/08; H04W 72/02; H04W 72/04; H04W 72/12

(52) U.S. Cl. CPC H04W 72/082; H04W 72/1215; H04W 72/1231; H04W 72/02; H04W 72/0446; H04W 88/06

(57) ABSTRACT

The present methods and apparatus relate to interference mitigation at a user equipment during wireless communication, comprising determining that a first portion of a first radio access technology (RAT) activity scheduled during a first time slot overlaps in duration with a second portion of a second RAT activity scheduled during a second time slot; excluding the first portion of the first RAT activity based at least in part on determining that the first portion of the first RAT activity overlaps in duration with the second portion of the second RAT activity; and performing a non-overlap portion of the first RAT activity during the first time slot, wherein the non-overlap portion of the first RAT activity is a portion of the first RAT activity that remains after excluding of the first portion of the first RAT activity.

### CLAIM OF PRIORITY UNDER 35 U.S.C §119

The present application for patent claims priority to Provisional Application No. PCT/CN2013/088121 entitled “METHODS AND APPARATUS FOR INTERFERENCE MITIGATION IN A WIRELESS COMMUNICATION SYSTEM” filed Nov. 29, 2013, assigned to the assignee hereof and hereby expressly incorporated herein by reference.

### BACKGROUND

Aspects of the present disclosure relate generally to wireless communication systems, and more particularly, to interference mitigation in a wireless communication system.

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

In some wireless communication networks, poor interference mitigation techniques may lead to failures in establishing or maintaining network connection. As a result, such failures may result in significant degradations in wireless communication performance and quality. Further, in such scenarios, limitations may exist in remedying the degradations. Thus, improvements in interference mitigation are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present methods relates to interference mitigation during wireless communication, comprising receiving a first activity schedule associated with a first radio access technology (RAT) and a second activity schedule associated with a second RAT, wherein the first activity schedule and the second activity schedule includes one or both of transmission activity and reception activity; and performing one or both of a first interference mitigation procedure and a second interference mitigation procedure to adjust the reception activity on one of the first RAT or the second RAT.

The present computer-readable medium storing computer executable code relates to interference mitigation during wireless communication, comprising code for receiving a first activity schedule associated with a first radio access technology (RAT) and a second activity schedule associated with a second RAT, wherein the first activity schedule and the second activity schedule includes one or both of transmission activity and reception activity; and code for performing one or both of a first interference mitigation procedure and a second interference mitigation procedure to adjust the reception activity on one of the first RAT or the second RAT.

The present apparatus relates to interference mitigation during wireless communication, comprising means for receiving a first activity schedule associated with a first radio access technology (RAT) and a second activity schedule associated with a second RAT, wherein the first activity schedule and the second activity schedule includes one or both of transmission activity and reception activity; and means for performing one or both of a first interference mitigation procedure and a second interference mitigation procedure to adjust the reception activity on one of the first RAT or the second RAT.

The present apparatus relates to interference mitigation during wireless communication, comprising a measurement adjustment component configured to receive a first activity schedule associated with a first radio access technology (RAT) and a second activity schedule associated with a second RAT, wherein the first activity schedule and the second activity schedule includes one or both of transmission activity and reception activity; and wherein the measurement adjustment component is further configured to perform one or both of a first interference mitigation procedure and a second interference mitigation procedure to adjust the reception activity on one of the first RAT or the second RAT.

In additional, the present methods relates to interference mitigation during wireless communication, comprising determining that a portion of a first radio access technology (RAT) activity overlaps in duration with a portion of a second RAT activity; determining that a priority value associated with the first RAT activity exceeds a priority value associated with the second RAT activity; and instructing a second RAT communication module to terminate the second RAT activity based at least in part on determining that the priority value associated with the first RAT activity exceeds the priority value associated with the second RAT activity.

The present computer-readable medium storing computer executable code relates to interference mitigation during wireless communication, comprising code for determining that a portion of a first radio access technology (RAT) activity overlaps in duration with a portion of a second RAT activity; code for determining that a priority value associated with the first RAT activity exceeds a priority value associated with the second RAT activity; and code for instructing a second RAT communication module to terminate the second RAT activity based at least in part on determining that the priority value associated with the first RAT activity exceeds the priority value associated with the second RAT activity.

The apparatus methods relates to interference mitigation during wireless communication, comprising means for determining that a portion of a first radio access technology (RAT) activity overlaps in duration with a portion of a second RAT activity; means for determining that a priority value associated with the first RAT activity exceeds a priority value associated with the second RAT activity; and means for instructing a second RAT communication module to terminate the second RAT activity based at least in part on determining that the priority value associated with the first RAT activity exceeds the priority value associated with the second RAT activity.

The present apparatus relates to apparatus for interference mitigation during wireless communication, comprising an overlap determination component configured to determine that a portion of a first radio access technology (RAT) activity overlaps in duration with a portion of a second RAT activity; a priority value comparator component configured to determine that a priority value associated with the first RAT activity exceeds a priority value associated with the second RAT activity; and a dynamic adjustment component configured to instruct a second RAT communication module to terminate the second RAT activity based at least in part on determining that the priority value associated with the first RAT activity exceeds the priority value associated with the second RAT activity.

Moreover, the present methods relates to interference mitigation during wireless communication, comprising determining that a first portion of a first radio access technology (RAT) activity scheduled during a first time slot overlaps in duration with a second portion of a second RAT activity scheduled during a second time slot; excluding the first portion of the first RAT activity based at least in part on determining that the first portion of the first RAT activity overlaps in duration with the second portion of the second RAT activity; and performing a non-overlap portion of the first RAT activity during the first time slot, wherein the non-overlap portion of the first RAT activity is a portion of the first RAT activity that remains after excluding of the first portion of the first RAT activity.

The present computer-readable medium storing computer executable code relates to interference mitigation during wireless communication, comprising code for determining that a first portion of a first radio access technology (RAT) activity scheduled during a first time slot overlaps in duration with a second portion of a second RAT activity scheduled during a second time slot; code for excluding the first portion of the first RAT activity based at least in part on determining that the first portion of the first RAT activity overlaps in duration with the second portion of the second RAT activity; and code for performing a non-overlap portion of the first RAT activity during the first time slot, wherein the non-overlap portion of the first RAT activity is a portion of the first RAT activity that remains after excluding of the first portion of the first RAT activity.

The present apparatus relates to interference mitigation during wireless communication, comprising means for determining that a first portion of a first radio access technology (RAT) activity scheduled during a first time slot overlaps in duration with a second portion of a second RAT activity scheduled during a second time slot; means for excluding the first portion of the first RAT activity based at least in part on determining that the first portion of the first RAT activity overlaps in duration with the second portion of the second RAT activity; and means for performing a non-overlap portion of the first RAT activity during the first time slot, wherein the non-overlap portion of the first RAT activity is a portion of the first RAT activity that remains after excluding of the first portion of the first RAT activity.

The present apparatus relates to interference mitigation during wireless communication, comprising an overlap determination component configured to determine that a first portion of a first radio access technology (RAT) activity scheduled during a first time slot overlaps in duration with a second portion of a second RAT activity scheduled during a second time slot; an excluding component configured to exclude the first portion of the first RAT activity based at least in part on determining that the first portion of the first RAT activity overlaps in duration with the second portion of the second RAT activity; and a communication component configured to perform a non-overlap portion of the first RAT activity during the first time slot, wherein the non-overlap portion of the first RAT activity is a portion of the first RAT activity that remains after excluding of the first portion of the first RAT activity.

Further, The present methods relates to interference mitigation during wireless communication, comprising receiving frequency measurements for a first Radio Access Technology (RAT) while a second RAT is engaged in a second RAT activity; determining whether the frequency measurements are adequate frequency measurements; and determining whether a number of the adequate frequency measurements meets or exceeds an adequate frequency measurement threshold value.

The present computer-readable medium storing computer executable code relates to interference mitigation during wireless communication, comprising code for receiving frequency measurements for a first Radio Access Technology (RAT) while a second RAT is engaged in a second RAT activity; code for determining whether the frequency measurements are adequate frequency measurements; and code for determining whether a number of the adequate frequency measurements meets or exceeds an adequate frequency measurement threshold value.

The present apparatus relates to interference mitigation during wireless communication, comprising means for receiving frequency measurements for a first Radio Access Technology (RAT) while a second RAT is engaged in a second RAT activity; means for determining whether the frequency measurements are adequate frequency measurements; and means for determining whether a number of the adequate frequency measurements meets or exceeds an adequate frequency measurement threshold value.

The present apparatus relates to interference mitigation during wireless communication, comprising a measurement management component configured to receive frequency measurements for a first Radio Access Technology (RAT) while a second RAT is engaged in a second RAT activity; an adequate management component configured to determine whether the frequency measurements are adequate frequency measurements; and a comparison component configured to determine whether a number of the adequate frequency measurements meets or exceeds an adequate frequency measurement threshold value.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

In order to facilitate a fuller understanding of the present disclosure, reference is now made to the accompanying drawings, in which like elements are referenced with like numerals, and where dashed lines may indicate optional components or actions. These drawings should not be construed as limiting the present disclosure, but are intended to be illustrative only, wherein:

FIG. 1 is a schematic diagram of a communication network including an aspect of a user equipment and network entity that may mitigate interference;

FIG. 2 is a schematic diagram of an aspect of the measurement adjustment component of FIG. 1;

FIG. 3 is a schematic diagram of an aspect of the dynamic adjustment component of FIG. 1;

FIG. 4 is a schematic diagram of an aspect of the TS management component of FIG. 1;

FIG. 5 is a schematic diagram of an aspect of the measurement management component of FIG. 1;

FIG. 6 is a flowchart of an aspect of mitigating interference at a user equipment, e.g., according to FIGS. 1 and 2;

FIG. 7 is a flowchart of an aspect of mitigating interference at a user equipment, e.g., according to FIGS. 1 and 3;

FIG. 8 is a flowchart of an aspect of mitigating interference at a user equipment, e.g., according to FIGS. 1 and 4;

FIG. 9 is a flowchart of an aspect of mitigating interference at a user equipment, e.g., according to FIGS. 1 and 5;

FIG. 10 is a conceptual diagram of an aspect of mitigating interference according at least to the measurement management component of FIG. 5;

FIG. 11 is a conceptual diagram of a further aspect of mitigating inference according at least to the measurement management component of FIG. 5;

FIG. 12 is a block diagram conceptually illustrating an example of a wireless communication system including an aspect of the user equipment and network entity described herein;

FIG. 13 is a block diagram conceptually illustrating an example of a frame structure in a wireless communication system including an aspect of the user equipment and network entity described herein;

FIG. 14 is a block diagram conceptually illustrating an example of the network entity of FIG. 1, in communication with the user equipment of FIG. 1, in a wireless communication system; and

FIGS. 15-18 are block diagrams each illustrating an example of several aspects of apparatuses configured to support communication as taught herein.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known components are shown in block diagram form in order to avoid obscuring such concepts. In an aspect, the term “component” as used herein may be one of the parts that make up a system, may be hardware or software, and may be divided into other components.

The present aspects generally relate to enhanced interference mitigation techniques in a wireless communication system. Specifically, in some wireless communication systems, a user equipment (UE) may communicate according to or on two or more radio access technologies (RATs). In such aspects, the UE may be configured with at least two subscriber identity modules (SIMs) to facilitate the multi-RAT communication at the UE (e.g., one SIM for each RAT supported). Moreover, with such configuration, the UE may concurrently communicate on or according to both SIMs. Nonetheless, in some aspects, the communication performed by the UE using one RAT (e.g., according to information stored on one SIM) may interfere with the communication performed by the UE using a different RAT (e.g., according to information stored on another SIM), resulting in communication degradation. For example, communication using a first RAT in a multi-RAT UE may include transmission of data at the same or substantially same time as receiving data through a second RAT in the multi-RAT UE. In such scenarios, when high power output signals are generated during transmission of data by the first RAT, the signals associated with the reception of data by the second RAT may experience radio frequency interference because of the coexistence (e.g., frequency coexistence) of the two RATs within a single, small form-factor device (e.g., UE).

As such, according to aspects of the present methods and apparatus, one or more interference mitigation techniques may be implemented to alleviate or otherwise prevent interference in a multi-RAT communication device, such as but not limited to a dual SIM dual active (DSDA) configured UE. In one aspect, the methods and apparatus may mitigate interference by detecting overlap portions in communication and/or receiving an indication signifying poor communication. In another aspect, the methods and apparatus may mitigate interference by detecting overlap portions in communication and selecting one communication according to an associated priority value. Additionally, the methods and apparatus may mitigate interference by excluding an overlap portion of communication. Further, in other aspects, the methods and apparatus may mitigate interference by facilitating service acquisition when a number of adequate measurements are determined. Accordingly, in some aspects, the present methods and apparatus may provide an efficient solution, as compared to current solutions, to mitigate interference in a multi-RAT communication environment, such as but not limited to a DSDA communication environment.

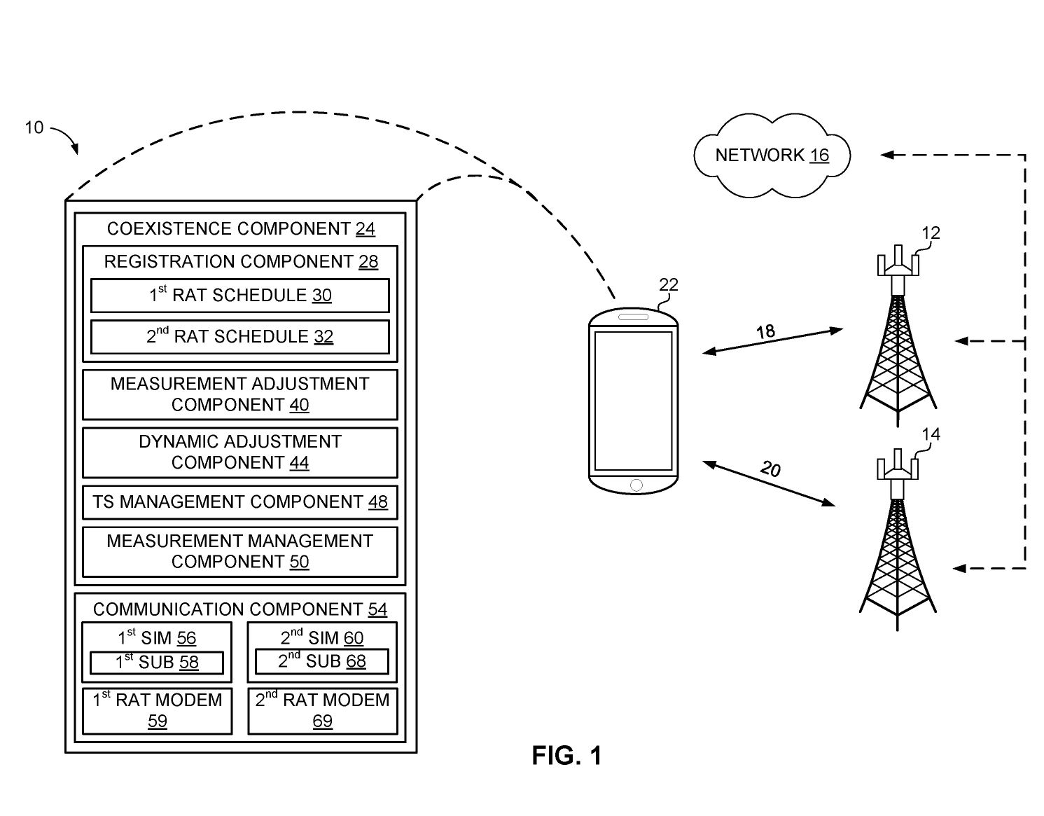

Referring to FIG. 1, in one aspect, a wireless communication system 10 includes at least one UE 22 for mitigating interference between a first communication activity (e.g., transmission/reception) on a first subscription 58 of a first SIM 56 (1^{st} SIM 56) and a second communication activity (e.g., transmission/reception) on a second subscription 68 of a second SIM 60 (2^{nd} SIM 60). In such aspects, UE 22 may be in communication coverage of at least a first network entity 12 communicating according to a first RAT (e.g., TD-SCDMA) and a second network entity 14 communicating according to a second RAT (e.g., GSM/Time-Division Long Term Evolution (TD-LTE)). However, it should be understood that one or both of first network entity 12 and second network entity 14 may communicate or operate according to the same or different RAT.

For instance, UE 22 may communicate with a first network entity 12 (e.g., on one or more communication channels 18) and/or a second network entity 14 (e.g., on one or more communication channels 20) utilizing multiple subscriptions to one or more networks (e.g., network 16). In an example, UE 22 can have a first subscription 58 associated with network 16 and second subscription 68 associated with the same network, such as network 16, or with a different network. Further, for example, each of first subscription 58 (1^{st} SUB 58) and second subscription 68 (2^{nd} SUB 68) may be associated with or otherwise relate to a different account and/or different services on the same network or on different networks.

In some aspects, first subscription 58 and second subscription 68 may be maintained on a respective first SIM 56 and a second SIM 60. As such, in one aspect, UE 22 may be a multi-SIM, multi-standby device, such as a dual-SIM, dual standby/active (DSDA) device. When supporting multiple SIMs, the UE 22 may also support multiple RATs for communication according to different subscriptions and/or services available as a result of having multiple SIMs. Accordingly, UE 22 may at least communicate with network 16 via a first network entity 12 using first subscription 58. Moreover, in other aspects, UE 22 may communicate with network 16 via first network entity 12 and/or via a different network entity, such as second network entity 14, using second subscription 68. Further, first network entity 12, second network entity 14, and/or network 16 may use the same or different radio access technologies (RAT) to facilitate communicating with UEs.

UE 22 may include communication component 54, which may configured to manage communication exchange signaling associated with first subscription 58 and/or second subscription 68 via a first RAT modem 59 and/or second RAT modem 69. For example, communication component 54 may include and execute communication protocols and/or manage other standards-specific communication procedures using protocol and/or standards-specific instructions and/or subscription-specific configuration information that allow communications with one or more of first network entity 12, second network entity 14, and/or network 16. Further, each of first RAT modem 59 and second RAT modem 69 may be configured to transmit and/or receive the communication exchange signaling to and/or from one or more network entities (e.g., base stations) or other devices in wireless communication system 10. For example, first RAT modem 59 (1^{st} RAT MODEM 59) may be configured to support wireless communications according to a first RAT and second RAT modem 69 (2^{nd} RAT MODEM 69) may be configured to support wireless communications according to a second RAT different from the first RAT.

For example, first RAT modem 59 and second RAT modem 69 may include, but are not limited to, one or more of a transmitter, a receiver, a transceiver, protocol stacks, transmit chain components, and receive chain components. In some aspects, first RAT modem 59 and second RAT modem 69 may be dedicated to operate according to the standards and procedures of a single one of first subscription 58 or second subscription 68 at any given time. For instance, although not to be construed as limiting, first RAT modem 59 and second RAT modem 69 may be associated with a multi-SIM, multi-standby device, such as a DSDS/DSDA device.

Moreover, communication component 54 may facilitate or otherwise enable UE 22 to communicate with first network entity 12 via one or more communication channels 18 according to or utilizing one or more RATs (e.g., TD-SCDMA). Additionally, UE 22 may communicate with second network entity 14 via one or more communication channels 20 according to or utilizing one or more RATs (e.g., GSM/TD-LTE). In such aspects, the one or more communication channels 18 and/or one or more communication channels 20 may enable communication on both the uplink and downlink between UE 22 and first network entity 12 and second network entity 14.

According to the present aspects, UE 22 may include coexistence component 24, which may be configured to mitigate interference between two or more active and/or concurrent communications associated with, for example, first subscription 58 (e.g., communicating on or according to first RAT) and second subscription 68 (e.g., communicating on or according to second RAT). For example, coexistence component 24 may be configured to minimize, reduce, or mitigate interference between on-going communications on two or more RATs. Specifically, in an aspect, coexistence component 24 may include registration component 28, which may be configured to receive, store, and/or otherwise maintain first RAT schedule 30 (1^{st} RAT schedule 30) and second RAT schedule 32 (2^{nd} RAT schedule 32). For example, first RAT schedule 30 may be associated with first subscription 58. The first RAT schedule 30 may be provided by, for example, first RAT modem 59 to identify activities associated with a first RAT to be performed by first RAT modem 59.

In such aspect, first RAT schedule 30 may include one or more communication activities (e.g., transmission and/or reception) during one or more time slots or a unit of time associated with the first RAT via communication component 54 and/or first RAT modem 59. Specifically, the schedule of communication activities may include information with regard to when the activity is scheduled to begin and end in time (e.g., duration in time), and information regarding the time slot for which the scheduled communication activities are to occur. The schedule of communication activities may also include information with regard to timing associated with periodic or regular activities.

Similarly, second RAT schedule 32 may be associated with second subscription 68. The second RAT schedule 32 may be provided by, for example, second RAT modem 69 to identify activities associated with a second RAT to be performed by second RAT modem 69.

In such aspect, second RAT schedule 32 may include a schedule of the transmission and/or reception activities during one or more time slots or a unit of time associated with the second RAT via communication component 54 and/or second RAT modem 69. Specifically, the schedule of communication activities may include information with regard to when the activity is scheduled to begin and end in time (e.g., duration in time), and information regarding the time slot for which the scheduled communication activities are to occur. The schedule of communication activities may also include information with regard to timing associated with periodic or regular activities.

In aspects described herein, coexistence component 24 may include measurement adjustment component 40, which may be configured to detect overlap portions in communication activities and/or may receive an indication signifying poor communication. In another aspect, coexistence component 24 may include dynamic adjustment component 44, which may be configured to mitigate interference by detecting or otherwise determining overlap portions in communication activities (e.g., overlapping activities in different RATs) and selecting to continue with only one communication activity, or a portion thereof, according to an associated priority value of each activity. Additionally, coexistence component 24 may include time slot (TS) management component 48, which may be configured to mitigate interference by excluding a determined overlap portion of the interfering communication. Further, in other aspects, coexistence component 24 may include measurement management component 50, which may be configured to mitigate interference by facilitating service acquisition when a number of adequate measurements are determined.

In some aspects, UE 22 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

Additionally, first network entity 12 and second network entity 14 may be a macrocell, picocell, femtocell, access point, relay, Node B, mobile Node B, UE (e.g., communicating in peer-to-peer or ad-hoc mode with UE 22), or substantially any type of component that can communicate with UE 22 to provide wireless network access at the UE 22.

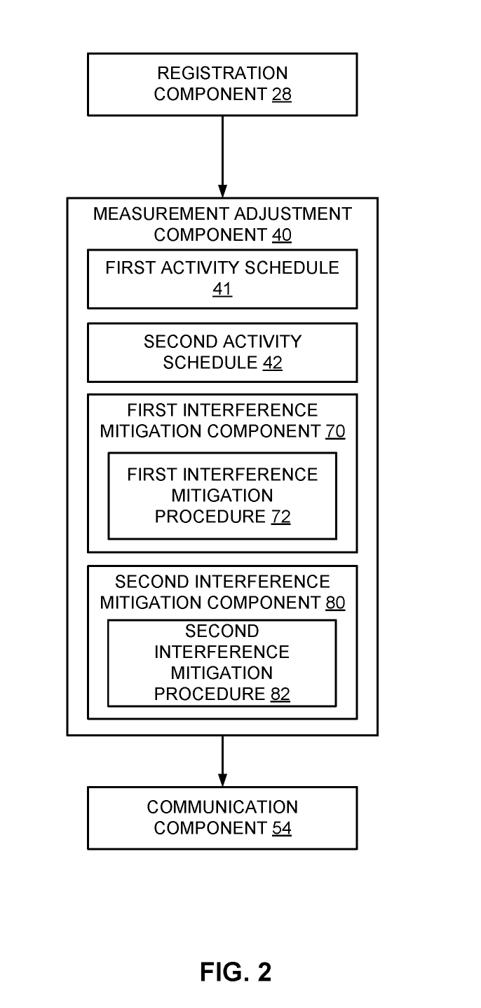

Referring to FIG. 2, an aspect of measurement adjustment component 40 may include various components and/or subcomponents, which may be configured to mitigate interference by determining overlap portions in communication to reschedule and/or receiving an indication in response to performing a communication activity which may signify poor communication. For example, measurement adjustment component 40 may be configured to receive a first activity schedule 41 associated with a first RAT and/or first subscription 58 (FIG. 1) and a second activity schedule 42 associated with a second RAT and/or second subscription 68 (FIG. 1) from registration component 28.

In such aspects, the first activity schedule 41 and the second activity schedule 42 may include one or both of transmission activity and/or reception activity for respective RAT communications. In other words, the first activity schedule 41 associated with first subscription 58 (FIG. 1), which may communicate according to or on a first RAT (e.g., GSM/TD-LTE), may include transmission activity (e.g., to first network entity 12, FIG. 1). Additionally, the second activity schedule 42 associated with second subscription 68 (FIG. 1), which may communicate according to or on a second RAT (e.g., TD-SCDMA), may include reception activity (e.g., from second network entity 14, FIG. 1). In some non-limiting aspects, the reception activity may include a frequency measurement during a time slot in a TD-SCDMA frame. For example, the frequency measurement may take place in time slot zero (TS0) of the TD-SCDMA frame, however a similar activity may take place in a different time slot.

In one aspect, measurement adjustment component 40 may include first interference mitigation component 70, which may be configured to mitigate interference by determining and resolving (e.g., rescheduling) overlaps in communication activity of or associated with first RAT and communication activity of or associated with second RAT. For example, first interference mitigation component 70 may be configured to determine that a portion of the first activity schedule 41 (e.g., received or otherwise obtained from registration component 28) overlaps (e.g., in the time domain) with a portion of the second activity schedule 42 (e.g., received or otherwise obtained from registration component 28).

In some aspects, the portion of the first activity schedule 41 may include transmission activity and the portion of the second activity schedule 42 may include reception activity. Further, an overlap between the communication activity of the first RAT (e.g., associated with first subscription 58) and the communication activity of the second RAT (e.g., associated with second subscription 68) may be determined when performance or execution of a portion of a first RAT activity (e.g., transmission) occurs at a same time or time duration of a scheduled second RAT activity (e.g., reception). In other words, an overlap may be determined or otherwise detected when a portion of a first RAT activity and a portion of a second RAT activity are scheduled or included in or during the same time slot.

Further, for instance, first interference mitigation component 70 may be configured to perform a first interference mitigation procedure 72, such as adjusting the second activity schedule 42 including the reception activity based at least in part on the determining that the portion of the first activity schedule 41 overlaps with the portion of the second activity schedule 42. For example, upon determining that the portion of the first activity schedule 41 (e.g., first RAT activity) overlaps in duration with the portion of the second activity schedule 42 (e.g., second RAT activity), first interference mitigation component 70 may be configured to adjust the second activity schedule 42 to, for example, reschedule the reception activity included within the second activity schedule 42 to a time slot non-overlapping with the portion of the first activity schedule 41. For example, when both a transmission activity over a first RAT and a reception activity over a second RAT are scheduled to occur during at least a portion of one time slot, the reception activity over the second RAT may be delayed to a subsequent time slot to avoid interference between signals generated by the transmission activity and signals received as part of the reception activity.

In further aspects, measurement adjustment component 40 may include second interference mitigation component 80, which may be configured to mitigate interference by performing a second interference mitigation procedure 82, such as detecting an indication of a poor communication activity in response to conducting or performing a scheduled reception activity. As such, when such an indication is received or detected, second interference mitigation component 80 may repeat or reschedule (e.g. delay) the reception activity to obtain an adequate communication result.

For example, second interference mitigation component 80 may be configured to perform or otherwise conduct reception activity for one of the first RAT (e.g., associated with first subscription 58, FIG. 1) and the second RAT (e.g., associated with second subscription 68, FIG. 1), according the first activity schedule 41 associated with the first RAT and the second activity schedule 42 associated with the second RAT. Further, second interference mitigation component 80 may be configured to receive or otherwise obtain a reception result message in response to performing the reception activity. In some aspects, the reception result message includes measurement result information (e.g., a poor communication activity result flag and/or an interference detection flag).

Additionally, second interference mitigation component 80 may be configured to determine that or otherwise whether the reception result message includes an interference indication. In some aspects, the interference indication comprises a flag or other marker indicating interference with the transmission activity of the other one of the first RAT (e.g., associated with first subscription 58, FIG. 1) and second RAT (e.g., associated with second subscription 68, FIG. 1). As such, when second interference mitigation component 80 determines that the interference indication is included in the reception result message, second interference mitigation component 80 may be configured to discard the measurement result information associated with the reception activity (e.g., frequency measurement on TS0).

In some aspects, the interference indication may be associated with one or more reception activities on one or more time slots according to the second RAT. In other aspects, second interference mitigation component 80 may be configured to instruct or provide an indication to second subscription 68 (FIG. 1) for repeating the reception activity at a subsequent time slot. For example, measurement adjustment component 40 may transmit an updated second RAT schedule or a portion thereof to communication component 54 for repeating the reception activity at a subsequent time slot.

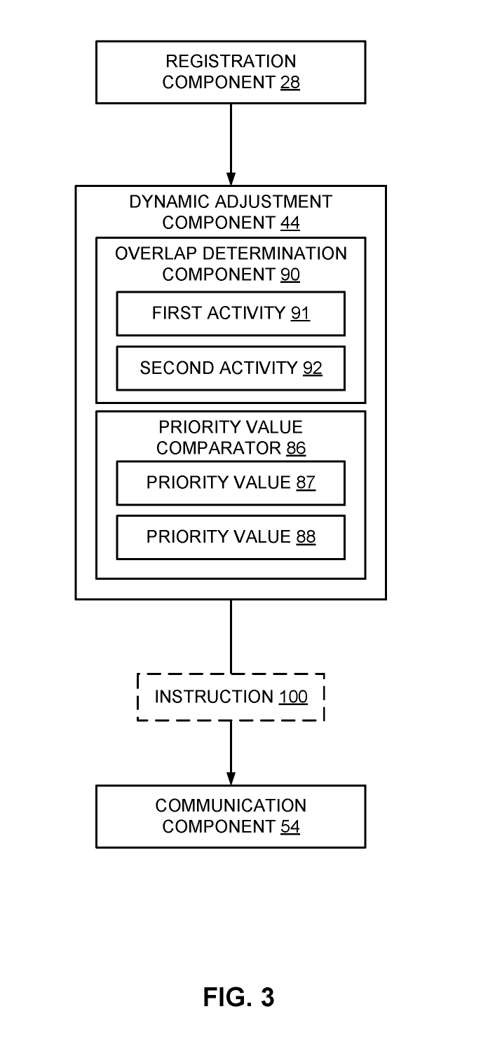

Referring to FIG. 3, an aspect of dynamic adjustment component 44 may include various components and/or subcomponents, which may be configured to mitigate interference by determining or otherwise detecting overlap portions in communication and selecting, executing and/or scheduling a communication activity over another communication activity according to an associated priority value. As such, dynamic adjustment component 44 may be configured to dynamically adjust the activity schedule of one or both first subscription 58 (FIG. 1), which may be associated with first RAT and the second subscription 68 (FIG. 1), which may be associated with second RAT.

For instance, dynamic adjustment component 44 may be configured to receive a first activity schedule (such as first RAT activity schedule 41 of FIG. 1), including one or more first activities 91 associated with a first RAT and/or first subscription 58 (FIG. 1) and a second activity schedule (such as second RAT activity schedule 42 of FIG. 1) including one or more second activities 92 associated with a second RAT and/or second subscription 68 (FIG. 1) from registration component 28. In such aspects, the first activity schedule and the second activity schedule may include one or both of transmission activity and/or reception activity. In other words, the first activity schedule associated with first subscription 58 (FIG. 1), which may communicate according to or on first RAT (e.g., GSM/TD-LTE), may include transmission and/or reception activity (e.g., to first network entity 12, FIG. 1).

Further, each communication activity that is identified by and/or received from registration component 28 for one or both of the first RAT and the second RAT may be associated with or assigned a priority value. In such aspects, the priority value may be a numerical value that designates a level of communication significance. For example, during handover/reselection, frequency measurements on one RAT may be prioritized over transmission activities on the other RAT. As such, the activity associated with handover/reselection may be assigned or associated with a higher priority value (e.g., higher or greater numerical value) than the priority value associated with other types of activities. Additionally, the second activity schedule associated with second subscription 68 (FIG. 1), which may communicate according to or on second RAT (e.g., TD-SCDMA), may include transmission and/or reception activity (e.g., from second network entity 14, FIG. 1). In some non-limiting aspects, the reception activity may include a frequency measurement during time slot zero (TS0).

In an aspect, dynamic adjustment component 44 may include overlap determination component 90, which may be configured to determine that a portion of a first RAT activity 91 overlaps in duration with a portion of a second RAT activity 92. For example, overlap determination component 90 may be configured to determine that a portion of the first RAT activity 91 (e.g., received or otherwise obtained from registration component 28) overlaps (e.g., in the time domain) with a portion of the second RAT activity 92 (e.g., received or otherwise obtained from registration component 28). The overlap determination component 90 may be configured to determine a percentage, a time, or some other parameter associated with the overlap. In some aspects, first RAT activity 91 and second RAT activity 92 may be referred to or be associated with a first RAT activity schedule (such as first RAT activity schedule 41 of FIG. 1) and a second RAT activity schedule (such as second RAT activity schedule 42 of FIG. 1), respectively.

In some aspects, the portion of the first RAT activity may include transmission activity and the portion of the second RAT activity may include reception activity. Further, an overlap between the communication activity of the first RAT (e.g., associated with first subscription 58) and the communication activity of the second RAT (e.g., associated with second subscription 68) may be determined when performance or execution of a portion of a first RAT activity 91 (e.g., transmission) occurs at a same time or time duration of a scheduled second RAT activity 92 (e.g., reception). In other words, an overlap may be determined or otherwise detected when a portion of a first RAT activity 91 and a portion of a second RAT activity 92 are scheduled or included in or during the same time slot.

In additional aspects, dynamic adjustment component 44 may include priority value comparator 96, which may be configured to determine whether a priority value 87 associated with the first RAT activity 91 meets and/or exceeds a priority value 88 associated with the second RAT activity 92. Accordingly, dynamic adjustment component 44 may be configured to instruct a second RAT communication module (e.g., second SIM 60, FIG. 1) to terminate (or delay, postpone) the second RAT activity 92 based at least in part on determining that the priority value 87 associated with the first RAT activity 91 exceeds the priority value 88 associated with the second RAT activity 92. For example, dynamic adjustment component 44 may be configured to transmit or communicate instruction 100 to communication component 54 to terminate the second RAT activity 92. It should be understood that dynamic adjustment component 44 may also be configured to halt or reschedule the overlapping RAT activity having lower priority to another time slot. Accordingly, the instruction 100 may also be used to convey halting or rescheduling information.

Further, dynamic adjustment component 44 may be configured to dynamically adjust one or both of the priority value 87 associated with the first RAT activity 91 and the priority value 88 associated with the second RAT activity 92. In some aspects, the adjustment may be based at least in part on determining that the portion of the first RAT activity 91 overlaps in duration with the portion of a second RAT activity 92. For example, dynamic adjustment component 44 may be configured to determine that an overlap in duration value meets or exceeds an overlap in duration threshold value and increase the priority value associated with the first RAT activity 91. In such aspects, the overlap in duration value may include an aggregate overlap in duration for the first RAT over a number of time slots. Additionally, dynamic adjustment may be based on determining that the overlap in duration value meets or exceeds the overlap in duration threshold value.

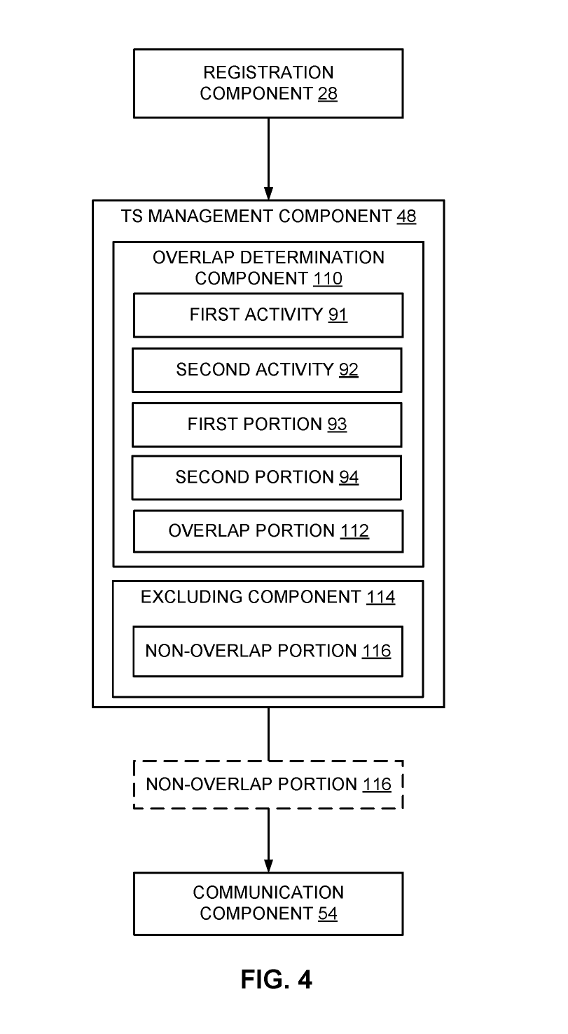

Referring to FIG. 4, an aspect of the TS management component 48 may include various components and/or subcomponents, which may be configured to mitigate interference by excluding an overlap portion of communication associated with or related to a first subscription 58 or a second subscription 68. Specifically, TS management component 48 may be configured to receive a first activity schedule (such as first RAT activity schedule 41 of FIG. 1) associated with a first RAT and/or first subscription 58 (FIG. 1) and a second activity schedule (such as second RAT activity schedule 42 of FIG. 1) associated with a second RAT and/or second subscription 68 (FIG. 1) from registration component 28.

In such aspects, the first activity schedule and the second activity schedule may include one or both of transmission activity and/or reception activity. In other words, the first activity schedule associated with first subscription 58 (FIG. 1), which may communicate according to or on first RAT (e.g., GSM/TD-LTE), may include transmission activity (e.g., to first network entity 12, FIG. 1). Additionally, the second activity schedule associated with second subscription 68 (FIG. 1), which may communicate according to or on second RAT (e.g., TD-SCDMA), may include reception activity (e.g., from second network entity 14, FIG. 1). In some non-limiting aspects, the reception activity may include a frequency measurement during time slot zero.

In an aspect, TS management component 48 may include overlap determination component 110, which may be configured to determine that a first portion 93 of a first activity scheduled (e.g., first RAT activity 91) during a first time slot overlaps in duration with a second portion 94 of a second activity scheduled (e.g., second RAT activity 92) during a second time. For example, overlap determination component 110 may be configured to determine that a first portion 93 of the first activity schedule (e.g., received or otherwise obtained from registration component 28) overlaps (e.g., in the time domain) with a second portion 94 of the second activity schedule (e.g., received or otherwise obtained from registration component 28). The overlap determination component 110 may be configured to determine a percentage, a time, or some other parameter associated with the overlap portion 112.

In some aspects, the portion of the first activity schedule may include reception activity and the portion of the second activity schedule may include transmission activity. Further, an overlap between the communication activity of the first RAT (e.g., associated with first subscription 58) and the communication activity of the second RAT (e.g., associated with second subscription 68) may be determined when performance or execution of a portion of a first RAT activity 91 (e.g., transmission) occurs at a same time or time duration of a scheduled second RAT activity 92 (e.g., reception). In other words, an overlap may be determined or otherwise detected when a portion of a first RAT activity 91 and a portion of a second RAT activity 92 are scheduled or included in or during the same time slot.

In some aspects, overlap determination component 110 may output an overlap portion 112 based in part on determining that a first portion 93 of a first activity scheduled (e.g., first RAT activity 91) during a first time slot overlaps in duration with a second portion 94 of a second activity scheduled (e.g., second RAT activity 92) during a second time.

In further aspects, TS management component 48 may include excluding component 114, which may be configured to exclude the first portion 93 of the first RAT activity 91 based at least in part on determining that the first portion 93 of the first RAT activity 91 overlaps in duration with the second portion 94 of the second RAT activity 92. For example, excluding component 114 may receive the overlap portion 112 from overlap determination component 110, and based in part on the overlap portion 112 may exclude the first portion 93 of the first RAT activity 91 that corresponds to the overlap portion 112. Additionally, excluding component 114 may only exclude first portion 93 of the first RAT activity 91 when the overlap in duration meets or exceeds an overlap duration threshold value. In some aspects, the overlap duration threshold value may be predetermined and/or automatically adjusted based in part on network conditions.

Further, excluding component 114 may determine whether the overlap in duration of the first portion 93 of the first RAT activity 91 occurs at a beginning portion or an end portion of a respective time slot (e.g., a first time slot). As a result, excluding component 114 may reschedule the performing when the overlap in duration of the first portion 93 of the first RAT activity 91 occurs at the beginning portion of the first time slot, remove or exclude the overlap in duration of the first portion 93 of the first RAT activity 91 when the overlap in duration of the first portion 93 of the first RAT activity 91 occurs at the end portion of the first time slot.

In such aspects, a non-overlap portion 116 of the first RAT activity 91 will remain as a result of excluding the first portion of the first RAT activity 91. In some aspects, the non-overlap portion 116 of the first RAT activity 91 may signify the portion of the first RAT activity 91 scheduled during the first time slot that is not affected by interference from the second portion 94 of the second RAT activity 92 scheduled during the second time slot. Moreover, TS management component 48 and/or excluding component 114 may output the second portion of the first RAT activity 91 to communication component 54 for performing the non-overlap portion 116 of the first RAT activity 91 during the first time slot.

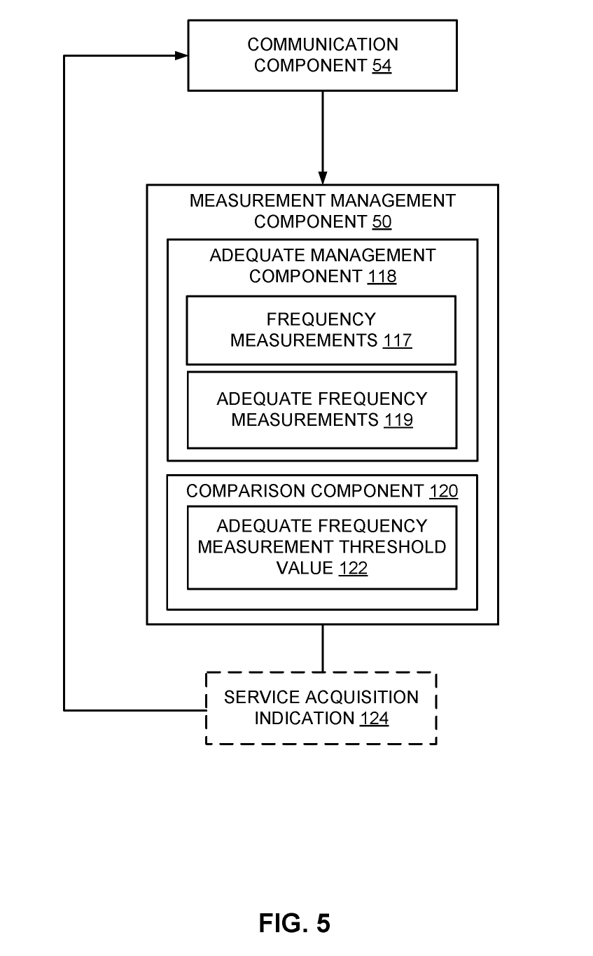

Referring to FIG. 5, an aspect of the measurement management component 50 may include various components and/or subcomponents, which may be configured to mitigate interference by facilitating service acquisition when a number of adequate measurements are determined. Specifically, communication component 54 may be configured to receive one or more frequency measurements 117 for a first RAT during a measurement window while a second RAT is engaged in a second activity schedule (e.g., second RAT activity), and transmit the frequency measurements 117 to measurement management component 50. Further, the measurement window is determined based at least in part on one or more of a length of an initial time slot of the first RAT, a length of a time slot of the second RAT time slot, and a maximum interference value of the initial time slot of the first RAT and the time slot of the second RAT.

In such aspects, the first activity schedule (such as first activity schedule 41 of FIG. 2) and the second activity schedule (such as second activity schedule 42 of FIG. 2) may include one or both of transmission activity and/or reception activity. In other words, the first activity schedule associated with first subscription 58 (FIG. 1), which may communicate according to or on first RAT (e.g., GSM/TD-LTE), may include transmission activity (e.g., to first network entity 12, FIG. 1). Additionally, the second activity schedule associated with second subscription 68 (FIG. 1), which may communicate according to or on second RAT (e.g., TD-SCDMA), may include reception activity (e.g., from second network entity 14, FIG. 1). In some non-limiting aspects, the reception activity may include a frequency measurement during time slot zero.

In an aspect, measurement management component 50 may include adequate management component 118, which may be configured to determine whether the frequency measurements 117 are adequate frequency measurements 119. For instance, adequate management component 118 may determine whether the second RAT activity is scheduled to transmit during the measurement window. In such aspects, when the second RAT activity is scheduled to transmit during the measurement window then adequate management component 118 may determine that adequate frequency measurements 119 do not exist for the frequency measurements 117. In some aspects, interference may occur when the second RAT activity is scheduled to transmit during the measurement window, so adequate management component 118 may determine that adequate frequency measurements 119 does not exist (e.g., may not be performed in view of the interference) for the frequency measurements 117. Further, adequate management component 118 may ignore the frequency measurements 117 that are not an adequate measurement (e.g., measurement taken in the presence of interference).

In further aspects, measurement management component 50 may include comparison component 120, which may be configured to determine whether a number of the adequate frequency measurements 119 meets or exceeds an adequate frequency measurement threshold value 122. For example, comparison component 120 may notify measurement management component 50 when the number of adequate frequency measurements 119 (e.g., frequency measurements 117 determined to be adequate based on knowledge of interference presence) does not meet or exceed an adequate frequency measurement threshold value 122. In such aspects, measurement management component 50 may notify communication component 54 to repeat receiving the frequency measurements 117 for the first RAT. Additionally, measurement management component 50 and/or adequate management component 118 may repeat determining whether the frequency measurements 117 are adequate frequency measurements 119 until the number of adequate frequency measurements 119 meets or exceeds the adequate measurement threshold value 122.

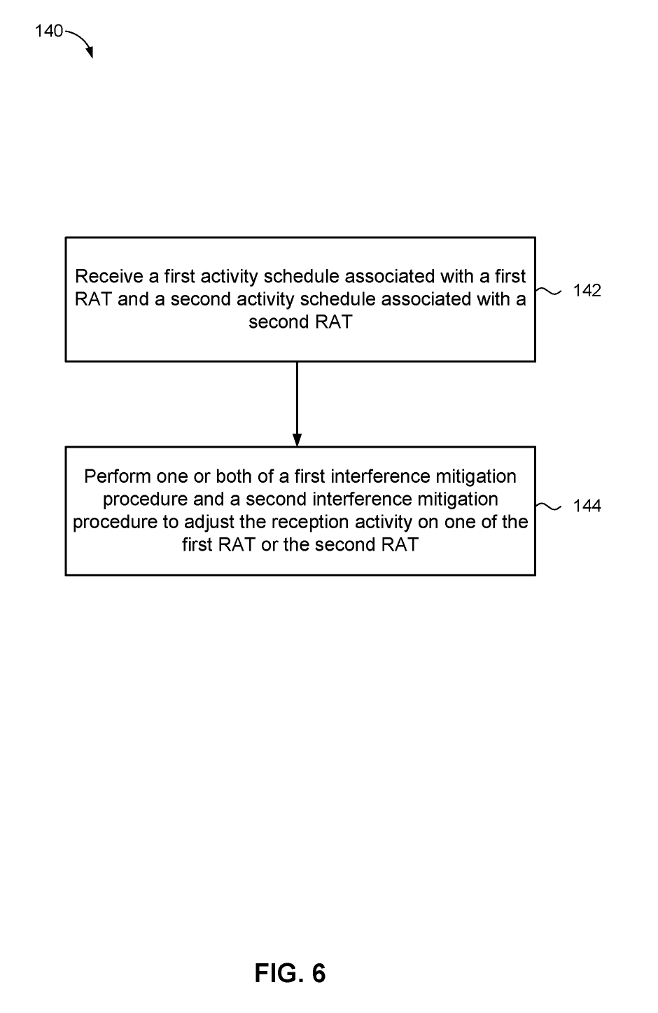

Referring to FIGS. 6-9, the methods are shown and described as a series of acts for purposes of simplicity of explanation. However, it is to be understood and appreciated that the methods (and further methods related thereto) are not limited by the order of acts, as some acts may, in accordance with one or more aspects, occur in different orders and/or concurrently with other acts from that shown and described herein. For example, it is to be appreciated that the methods may alternatively be represented as a series of interrelated states or events, such as in a state diagram. Moreover, not all illustrated acts may be required to implement a method in accordance with one or more features described herein.

Referring to FIG. 6, in operation, a UE such as UE 22 (FIG. 1) including coexistence component 24 may perform one aspect of a method 140 for mitigating interference between two or more actively communicating subscriptions (e.g., communicating according to two different RATs). As described in further detail below, method 140 provides a process which may enhance interference mitigation at a UE (e.g., UE 22, FIG. 1).

In an aspect, at block 142, method 140 may include receiving a first activity schedule associated with a first RAT and a second activity schedule associated with a second RAT. For example, as described herein, coexistence component 24 (FIG. 1) may execute measurement adjustment component 40 (FIGS. 1 and 2), to receive a first activity schedule 41 associated with a first RAT (e.g., TD-SCDMA) and a second activity schedule 42 associated with a second RAT (e.g., GSM/TD-LTE). In some aspects, the first activity schedule 41 and the second activity schedule 42 may include one or both of transmission activity and reception activity.

Further, at block 144, method 140 may include performing one or both of a first interference mitigation procedure and a second interference mitigation procedure to adjust the reception activity on one of the first RAT or the second RAT. For instance, as described herein, coexistence component 24 (FIG. 1) may execute measurement adjustment component 40 (FIGS. 1 and 2), to perform one or both of a first interference mitigation procedure 72 (FIG. 2) and a second interference mitigation procedure 82 (FIG. 2) to adjust the reception activity on one of the first RAT or the second RAT. Examples of the first interference mitigation procedure 72 and the second interference mitigation procedure 82 are described herein at least with respect to FIGS. 1-5.

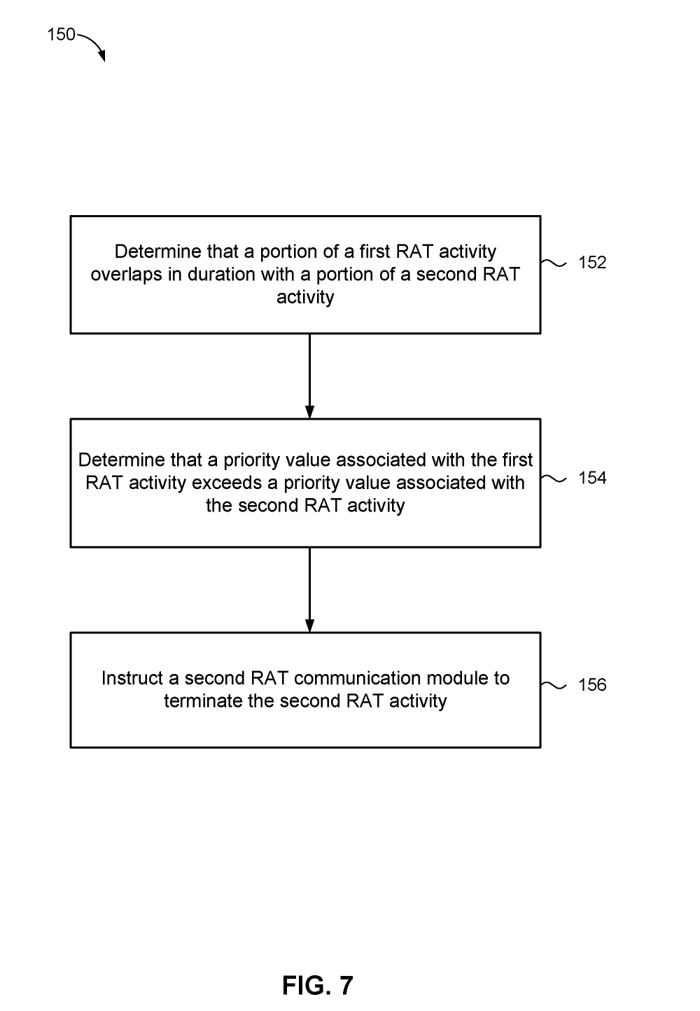

Referring to FIG. 7, in operation, a UE such as UE 22 (FIG. 1) including coexistence component 24 may perform one aspect of a method 150 for mitigating interference between two or more actively communicating subscriptions (e.g., communicating according to two different RATs). As described in further detail below, method 140 provides a process which may enhance interference mitigation at a UE (e.g., UE 22, FIG. 1).

In an aspect, at block 152, method 150 may include determining that a portion of a first RAT activity overlaps in duration with a portion of a second RAT activity. For example, as described herein, coexistence component 24 (FIG. 1) may execute dynamic adjustment component 44 (FIGS. 1 and 3) and/or overlap determination component 90 (FIG. 3), to determine that a portion of a first RAT activity 91 overlaps in duration with a portion of a second RAT activity 92.

Further, at block 154, method 150 may include determining that a priority value associated with the first RAT activity exceeds a priority value associated with the second RAT activity. For instance, as described herein, coexistence component 24 (FIG. 1) may execute dynamic adjustment component 44 (FIGS. 1 and 3) and/or priority value comparator 96 (FIG. 3), to determine that a priority value 87 associated with the first RAT activity 91 exceeds a priority value 88 associated with the second RAT activity 92.

At block 156, method 150 may include instructing a second RAT communication module to terminate the second RAT activity. For example, as described herein, coexistence component 24 (FIG. 1) may execute dynamic adjustment component 44 (FIGS. 1 and 3), to instruct a second RAT communication module to terminate (e.g., termination instruction 100, FIG. 3) the second RAT activity. In some aspects, the termination instruction 100 (FIG. 3) may be triggered or otherwise transmitted based at least in part on determining that the priority value 87 associated with the first RAT activity 91 exceeds the priority value 88 associated with the second RAT activity 92.

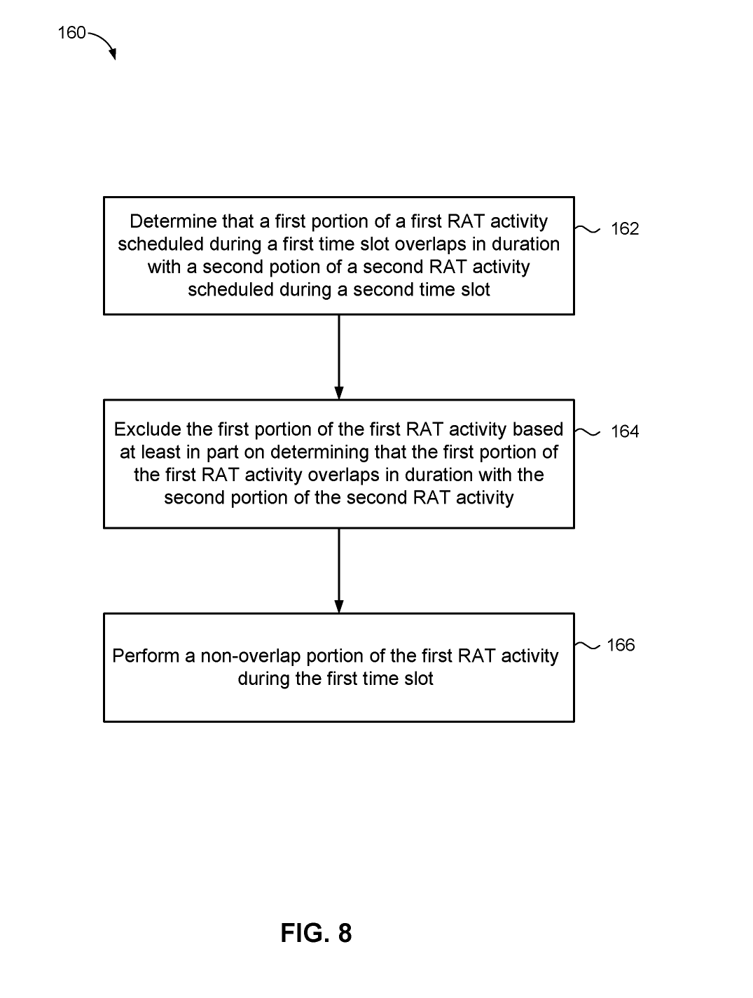

Referring to FIG. 8, in operation, a UE such as UE 22 (FIG. 1) may perform one aspect of a method 160 for mitigating interference by excluding an overlap portion of communication associated with or related to a first subscription 58 or a second subscription 68. As described herein, the functional block diagram 160 provides a process tailored to mitigate interference by excluding an overlap portion of communication associated with or related to a first subscription 58 or a second subscription 68 at the UE 22 (FIG. 1).

In an aspect, at block 162, method 160 include determining that a first portion of a first RAT activity scheduled during a first time slot overlaps in duration with a portion of a second RAT activity scheduled during a second time slot. For instance, as described herein, UE 22 (FIG. 1) or coexistence component 24 may execute TS management component 48 and/or overlap determination component 110 (FIG. 4) to determine that a first portion 93 of a first RAT activity 91 scheduled within first RAT schedule 30 during a first time slot overlaps in duration with a second portion 94 of a second RAT activity 92 scheduled within second RAT schedule 32 during a second time slot resulting in overlap portion 112. In some aspects, TS management component 48 and/or overlap determination component 110 may receive and/or access the first RAT activity 91 scheduled and the second RAT activity 92 scheduled from the registration component 28 and/or first RAT schedule 30 and second RAT schedule 32, and output the overlap portion 112.

Moreover, at block 164, method 160 may include excluding the first portion of the first RAT activity based at least in part on determining that the first portion of the first RAT activity overlaps in duration with the portion of the second RAT activity. For instance, as described herein, UE 22 (FIG. 1) or coexistence component 24 may execute TS management component 48 and/or excluding component 114 (FIG. 4) to remove or exclude the first portion 93 of the first RAT activity 91 based at least in part on determining that the first portion 93 of the first RAT activity 91 overlaps in duration with the second portion 94 of the second RAT activity 92. In some aspects, TS management component 48 and/or excluding component 114 may use overlap portion 112 to exclude the first portion 93 of the first RAT activity 91 to generate a non-overlap portion 116 of the first RAT activity 91. TS management component 48 and/or excluding component 114 may exclude the first portion 93 of the first RAT activity 91 when the overlap in duration meets or exceeds an overlap duration threshold value.

Additionally, TS management component 48 and/or excluding component 114 may determine whether the overlap in duration of the first portion of the first RAT activity occurs at a beginning portion or an end portion of the first time slot. TS management component 48 and/or excluding component 114 may reschedule the performing step of block 4 when the overlap in duration of the first portion 93 of the first RAT activity 91 occurs at the beginning portion of the first time slot, or remove the overlap in duration of the first portion of the first RAT activity when the overlap in duration of the first portion 93 of the first RAT activity 91 occurs at the end portion of the first time slot. As such, the second portion of the first RAT activity 91 is the portion of the first RAT activity 91 that remains after the excluding of the overlap in duration of the first portion 93 of the first RAT activity 91 occurs. As a result, TS management component 48 and/or excluding component 114 may output the non-overlap portion 116 of the first RAT activity 91 to the communication component 54.

In addition, at block 166, method 160 may include performing a second portion of the first RAT activity during the first time slot, wherein the second portion of the first RAT activity is a portion of the first RAT activity that remains after the excluding of the overlap in duration of the first portion of the first RAT activity. For example, as described herein, UE 22 (FIG. 1) may execute communication component 54 and/or first RAT modem 59 to receive the non-overlap portion 116 of the first RAT activity 91 and perform the non-overlap portion 116 of the first RAT activity 91 during the first time slot. As a result, the communication component 54 and or first RAT modem may perform measurements and decoding on the non-overlap portion 116 of the first RAT activity 91.

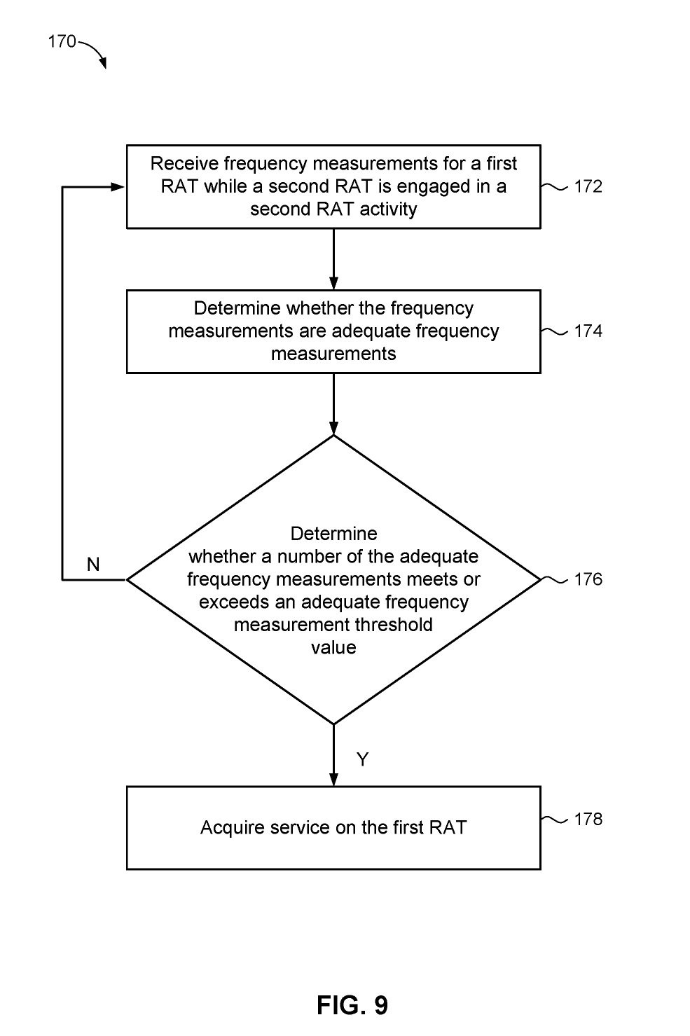

Referring to FIG. 9, in operation, a UE such as UE 22 (FIG. 1) may perform one aspect of a method 170 for mitigating interference by facilitating service acquisition when a number of adequate measurements are determined. As described herein, the functional block diagram 170 provides a process tailored to mitigate interference by facilitating service acquisition when a number of adequate measurements are determined at the UE 22 (FIG. 1).

In an aspect, at block 172, method 170 optionally include receiving a frequency measurement for a first RAT while a second RAT is engaged in a second RAT activity. For example, as described herein, UE 22 (FIG. 1) may execute communication component 54 and/or first RAT modem 59 to scan for frequency measurements on a specific frequency and receiving a frequency measurement for a first RAT while a second RAT is engaged in a second RAT activity while a second RAT is engaged in a second RAT activity on communication component 54 and/or second RAT modem. In an aspect, communication component 54 and/or first RAT modem 59 may receive the frequency measurement for the first RAT during a measurement window. The measurement window may be determined based at least in part on one or more of a length of an initial time slot of the first RAT, a length of a time slot of the second RAT time slot, and a maximum interference value of the initial time slot of the first RAT and the time slot of the second RAT.

At block 174, method 170 may include determining whether the frequency measurement is an adequate frequency measurement. For instance, as described herein, UE 22 (FIG. 1) or coexistence component 24 may execute measurement management component 50 and/or adequate management component 118 (FIG. 5) to determine whether the frequency measurement is an adequate frequency measurement. In some aspects, measurement management component 50 and/or adequate management component 118 may receive and/or access the received frequency measurements from communication component 54, determine whether the frequency measurement is an adequate frequency measurement, and output the adequate frequency measurement to the comparison component 120. In an aspect, determining whether the frequency measurement is an adequate measurement may comprise determining whether the second RAT activity is scheduled to transmit during the measurement window. Further, if it determined that the frequency measurement is not an adequate measurement then measurement management component 50 and/or adequate management component 118 may ignore the frequency measurement and optionally discard the frequency measurement.

Moreover, at block 176, method 170 may include determining whether a number of the adequate frequency measurements meets or exceeds an adequate frequency measurement threshold value. For instance, as described herein, UE 22 (FIG. 1) or coexistence component 24 may execute measurement management component 50 and/or comparison component 120 (FIG. 5) to determine whether a number of the adequate frequency measurements meets or exceeds an adequate frequency measurement threshold value 122. In some aspects, if the number of the adequate frequency measurements does not meet or exceed the adequate frequency measurement threshold value 122 then method 170 will return to block 174, and repeat receiving the frequency measurement for the first RAT and determining whether the frequency measurement is an adequate frequency measurement until the number of adequate frequency measurements meets or exceeds the adequate measurement threshold value. In another aspect, if the number of number of the adequate frequency measurements meets or exceeds an adequate frequency measurement threshold value 122 then measurement management component 50 and/or comparison component 120 may output a service acquisition indication 124.

In addition, at block 178, method 170 may include acquiring service on the first RAT when a number of the adequate frequency measurements meets or exceeds the adequate frequency measurement threshold value. For example, as described herein, UE 22 (FIG. 1) may execute communication component 54 and/or 1^{st} RAT modem 59 to receive the service acquisition indication 124 and acquire service on the first RAT. As a result, the communication component 54 and or Pt RAT modem may transmit a service acquisition request to one or both network entity 12 and network entity 14.

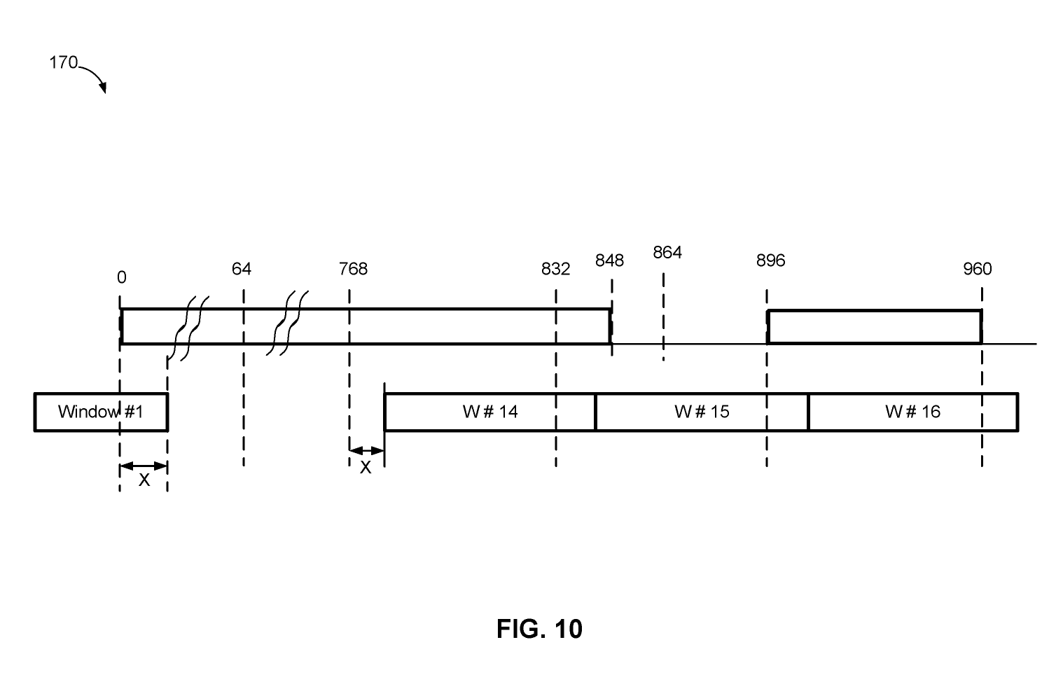

Turning now to FIG. 10, a conceptual diagram is shown illustrating an example of a UE such as UE 22 (FIG. 1) performing a process to mitigate interference by facilitating service acquisition when a number of adequate measurements are determined (e.g., measurement management component 50, FIGS. 1 and 5). In FIG. 10, diagram 180 includes a representation of the frequency scan process when a 2^{nd} activity (e.g., 2^{nd} RAT activity) may cause interference for measurements received on the Pt RAT. In one aspect, UE may use 64-chip-wide windows for measurement on the 1^{st} RAT with a focus on the initial time slot of the Pt RAT (e.g., TS0+DwPTS) area for a power scan. The length of the initial time slot of the Pt RAT may be set (e.g., 960 cxl or an equivalent of 15 windows). In some aspects, 16 windows may cover the length of TS0+DwPTS. Further, the length of a time slot of the 2^{nd} RAT (e.g., GSM slot) may be set (e.g., 738 cxl or an equivalent of 11.53 windows). As such the 2^{nd} RAT activity may potentially cause interference on a maximum of 13 windows even with tuning and power amplification (e.g., on/off time).

Moreover, the adequate frequency measurement threshold value may be set (e.g., 87 windows reflecting adequate frequency measurements). As such, UE 22 and/or measurement management component 50 may determine whether the 2^{nd} RAT activity is scheduled for a current time slot, and if so, scan for a shortened time period (e.g., 5 ms). If UE 22 and/or measurement management component 50 determines that the 2^{nd} RAT activity is not scheduled for a current time slot, then successive scanning may occur until the number of adequate frequency measurements meets or exceeds the adequate frequency measurement threshold value. Further, if the number of consecutive 2^{nd} RAT activity time slots active are 2, 3, or 4, then UE 22 and/or measurement management component 50 may scan frequency measurements 3, 5, or 6 times for the Pt RAT, respectively.

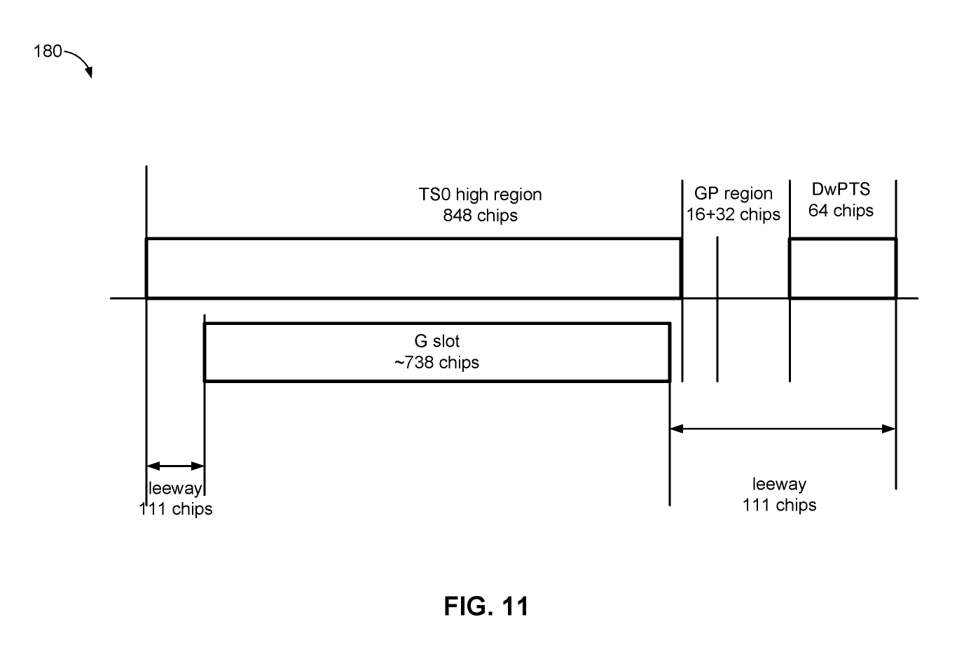

FIG. 11 refers to a conceptual diagram illustrating a further aspect of a UE such as UE 22 (FIG. 1) performing a process to mitigate interference by facilitating service acquisition when a number of adequate measurements are determined (e.g., measurement management component 50, FIGS. 1 and 5). In FIG. 11, diagram 190 includes a representation of an aspect for reducing window size. In one aspect, the number of active slots in the 2^{nd} RAT activity (e.g., GSM transmit) may be set. As such, depending on the initial scan length (e.g., 5 ms) for scanning frequency measurements on the 1^{st} RAT, the process may lose a plurality of adequate frequency measurements (e.g., a maximum of 13 adequate frequency measurements). Additionally, rescanning may provide at least a number of new adequate frequency measurements (e.g., at least 6 adequate frequency measurements). The subsequent scan may cause the relative position of the 2^{nd} RAT activity to move (e.g., move backwards by potentially 492 cxl or an equivalent of 7.68 windows), resulting in a skew (e.g., a skew of at least 6 windows). Further, even if one 2^{nd} RAT activity (e.g., GSM transmit slot) is active, the probability of an adequate frequency measurement for the frequency measurement of the 1^{st} RAT (e.g., TDS receive slot or TS0+DwPTS) will be low if the window length is set to a value that it too high (e.g., a window length of 128). Additionally, the probability will decrease even further if more than one 2^{nd} RAT activity (e.g., GSM transmit slot) is active.

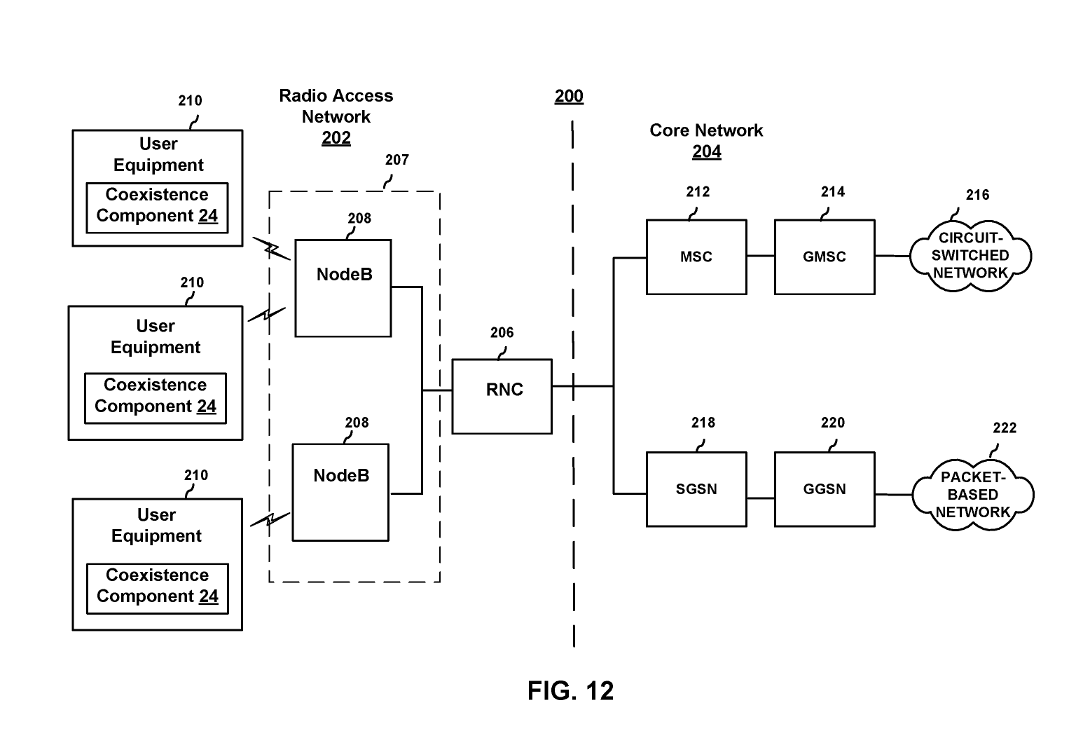

Turning now to FIG. 12, a block diagram is shown illustrating an example of a telecommunications system 200 in which UE 22 including coexistence component 24, may operate, such as in the form of or as a part of UEs 210, and one or more Node Bs 208 may operate according to first network entity 12 (FIG. 1) and/or second network entity 14 (FIG. 1). The various concepts presented throughout this disclosure may be implemented across a broad variety of telecommunication systems, network architectures, and communication standards. By way of example and without limitation, the aspects of the present disclosure illustrated in FIG. 4 are presented with reference to a UMTS system employing a TD-SCDMA standard. In this example, the UMTS system includes a (radio access network) RAN 202 (e.g., UTRAN) that provides various wireless services including telephony, video, data, messaging, broadcasts, and/or other services.

The RAN 202 may be divided into a number of Radio Network Subsystems (RNSs) such as an RNS 207, each controlled by a Radio Network Controller (RNC) such as an RNC 206. For clarity, only the RNC 206 and the RNS 207 are shown; however, the RAN 202 may include any number of RNCs and RNSs in addition to the RNC 206 and RNS 207. The RNC 206 is an apparatus responsible for, among other things, assigning, reconfiguring and releasing radio resources within the RNS 207. The RNC 206 may be interconnected to other RNCs (not shown) in the RAN 202 through various types of interfaces such as a direct physical connection, a virtual network, or the like, using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 208 are shown, however, the RNS 207 may include any number of wireless Node Bs. The Node Bs 208 provide wireless access points to a core network 204 for any number of mobile apparatuses.

Initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 210 are shown in communication with the Node Bs 208, each of which may include or otherwise be configured to operate according to the aspects described herein with respect to the coexistence component 24 (FIGS. 1-9). The downlink (DL), also called the forward link, refers to the communication link from a Node B to a UE, and the uplink (UL), also called the reverse link, refers to the communication link from a UE to a Node B.

The core network 204, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 204 supports circuit-switched services with a mobile switching center (MSC) 212 and a gateway MSC (GMSC) 214. One or more RNCs, such as the RNC 206, may be connected to the MSC 212. The MSC 212 is an apparatus that controls call setup, call routing, and UE mobility functions. The MSC 212 also includes a visitor location register (VLR) (not shown) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR to determine the UE's location and forwards the call to the particular MSC serving that location.

The core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard GSM circuit-switched data services. The GGSN 220 provides a connection for the RAN 202 to a packet-based network 222. The packet-based network 222 may be the Internet, a private data network, or some other suitable packet-based network. The primary function of the GGSN 220 is to provide the UEs 210 with packet-based network connectivity. Data packets are transferred between the GGSN 220 and the UEs 210 through the SGSN 218, which performs primarily the same functions in the packet-based domain as the MSC 212 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 208 and a UE 210, but divides uplink and downlink transmissions into different time slots in the carrier.

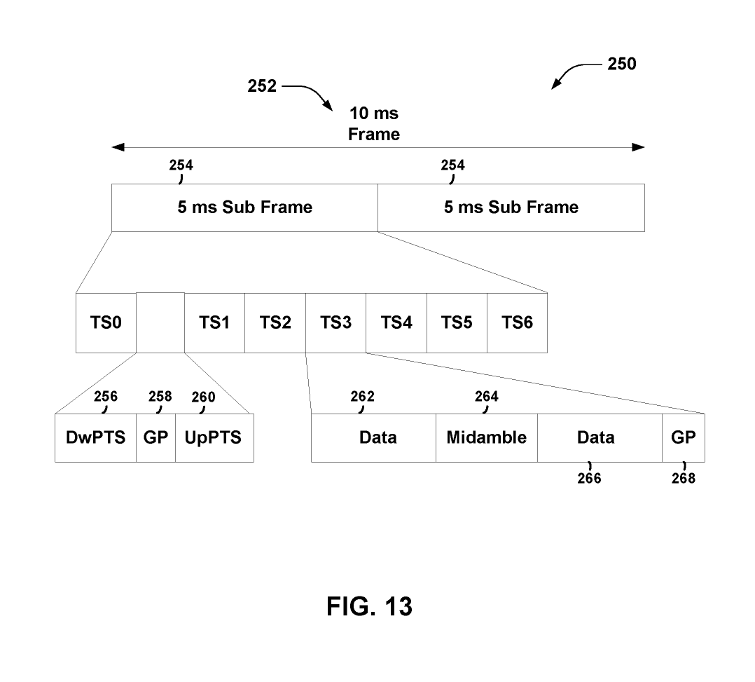

FIG. 13 illustrates one aspect of a frame structure 250 for a TD-SCDMA carrier, which may be used in communications between UE 22 (FIG. 1) including coexistence component 24 and one or both of first network entity 12 (FIG. 1) and second network entity 14 (FIG. 1), as described herein. The TD-SCDMA carrier, as illustrated, has a frame 252 that may be 10 ms in length. The frame 252 may have two 5 ms subframes 254, and each of the subframes 254 includes seven time slots, TS0 through TS6. The first time slot, TS0, may be allocated for inter/intra frequency measurements and/or downlink communication, while the second time slot, TS1, may be allocated for uplink communication.

The remaining time slots, TS2 through TS6, may be used for either uplink or downlink, which allows for greater flexibility during times of higher data transmission times in either the uplink or downlink directions. A downlink pilot time slot (DwPTS) 256, a guard period (GP) 258, and an uplink pilot time slot (UpPTS) 260 (also known as the uplink pilot channel (UpPCH)) are located between TS0 and TS1. Each time slot, TS0-TS6, may allow data transmission multiplexed on a maximum of, for instance, 16 code channels. Data transmission on a code channel includes two data portions 262 separated by a midamble 264 and followed by a guard period (GP) 268. The midamble 264 may be used for features, such as channel estimation, while the GP 268 may be used to avoid inter-burst interference.

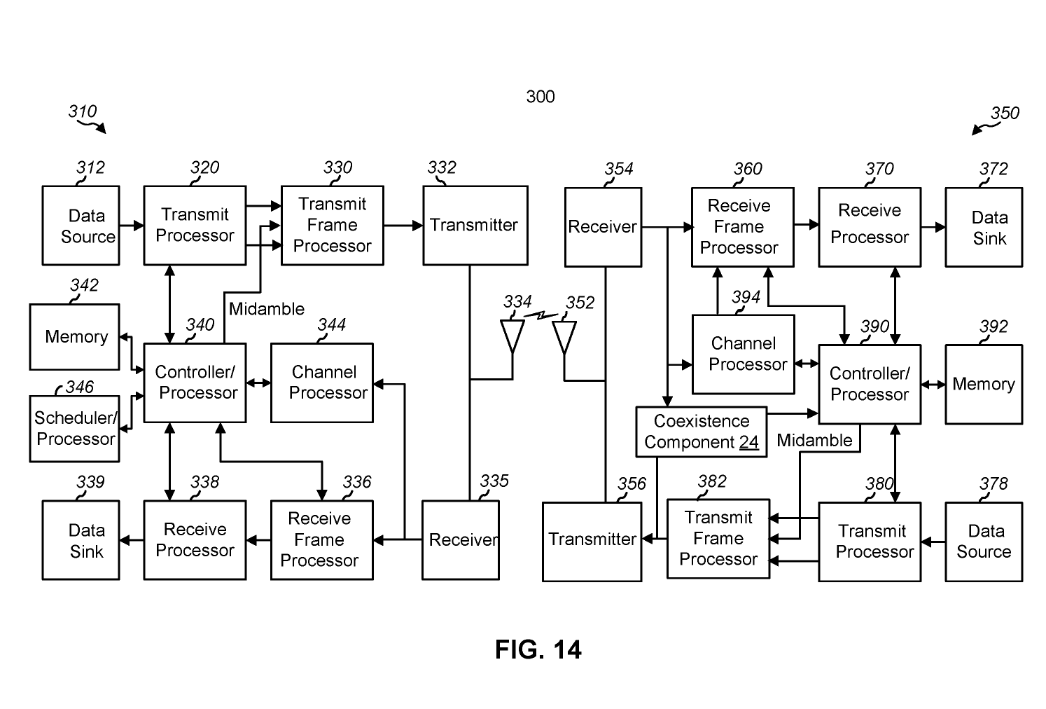

FIG. 14 is a block diagram 300 of a Node B 310 in communication with a UE 350 in a RAN 300, where RAN 300 may be the same as or similar to RAN 202 in FIG. 10, the Node B 310 may be the same as or similar to Node B 208 in FIG. 10, where the UE 350 may be the same as or similar to UE 210 in FIG. 10 or the UE 22 including coexistence component 24 in FIG. 1. In other aspects, UE 350 may include coexistence component 24, and thereby may be configured to operate according to the aspects described herein with respect to thereof. In the downlink communication, a transmit processor 320 may receive data from a data source 312 and control signals from a controller/processor 340. The transmit processor 320 provides various signal processing functions for the data and control signals, as well as reference signals (e.g., pilot signals).

For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols.

Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 11) from the UE 350. The symbols generated by the transmit processor 320 are provided to a transmit frame processor 330 to create a frame structure. The transmit frame processor 330 creates this frame structure by multiplexing the symbols with a midamble 214 (FIG. 8) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 11) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352. The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 11) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

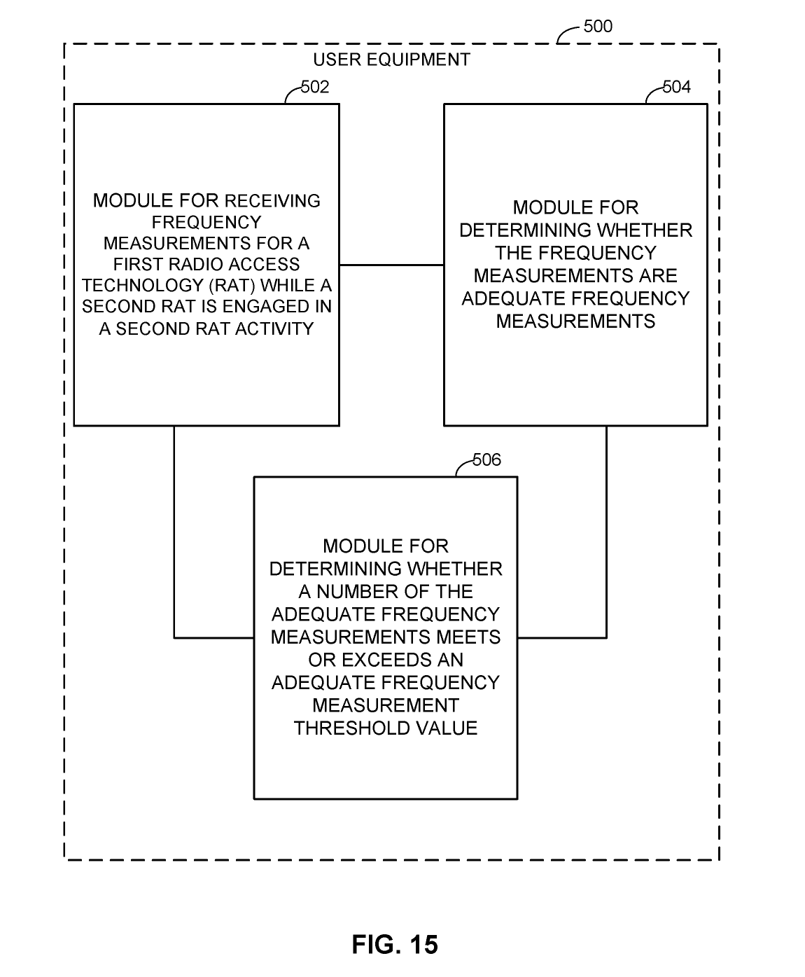

FIG. 15 illustrates an example UE 500 represented as a series of interrelated functional modules, wherein the UE 500 may be the same as or similar to UE 22 (FIG. 1) including measurement adjustment component 40 (FIG. 1). In an aspect, UE 500 includes a module 502 for receiving a first activity schedule associated with a first radio access technology (RAT) and a second activity schedule associated with a second RAT, wherein the first activity schedule and the second activity schedule includes one or both of transmission activity and reception activity. Module 502 may correspond to, for example, a processing system as discussed herein. Further, in an aspect, UE 500 includes a module 504 for performing one or both of a first interference mitigation procedure and a second interference mitigation procedure to adjust the reception activity on one of the first RAT or the second RAT. Module 504 may correspond to, for example, a processing system as discussed herein.

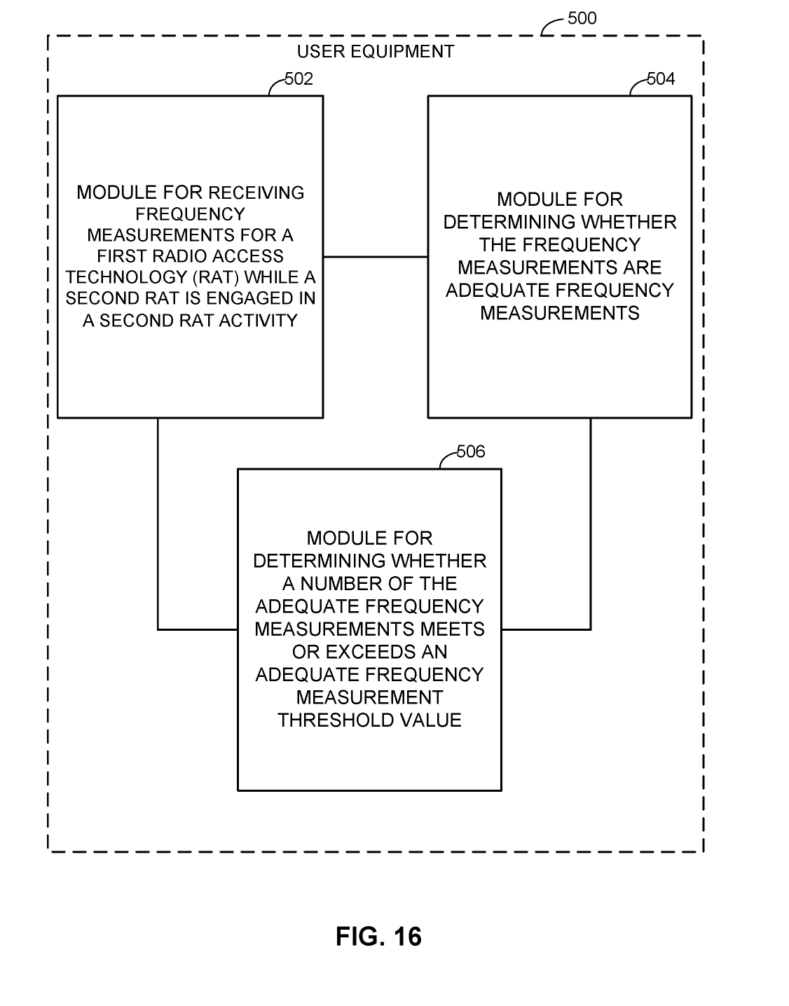

FIG. 16 illustrates an example UE 600 represented as a series of interrelated functional modules, wherein the UE 600 may be the same as or similar to UE 22 (FIG. 1) including dynamic adjustment component 44 (FIG. 1). In an aspect, access UE 600 includes a module 602 for determining that a portion of a first radio access technology (RAT) activity overlaps in duration with a portion of a second RAT activity. Module 602 may correspond to, for example, a processing system as discussed herein. Further, in an aspect, UE 600 includes a module 604 for determining that a priority value associated with the first RAT activity exceeds a priority value associated with the second RAT activity. Module 604 may correspond to, for example, a processing system as discussed herein. Moreover, in an aspect, UE 600 includes a module 606 for instructing a second RAT communication module to terminate the second RAT activity based at least in part on determining that the priority value associated with the first RAT activity exceeds the priority value associated with the second RAT activity. Module 606 may correspond to, for example, a processing system as discussed herein.

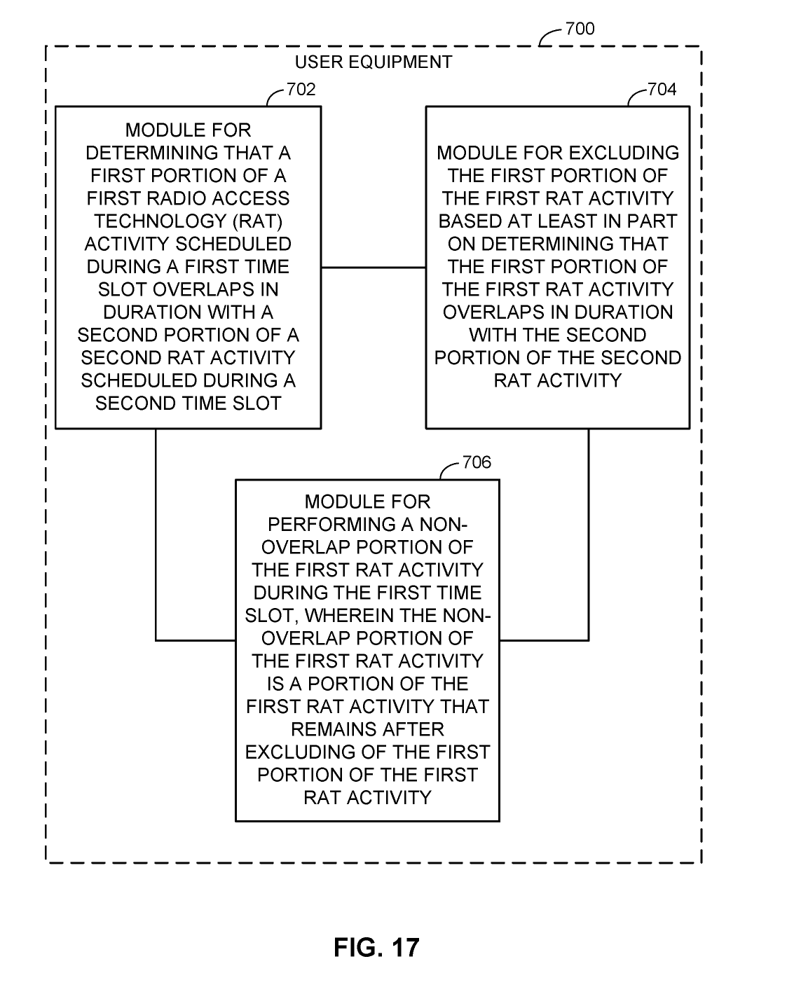

FIG. 17 illustrates an example UE 700 represented as a series of interrelated functional modules, wherein the UE 700 may be the same as or similar to UE 22 (FIG. 1) including TS management component component 48 (FIG. 1). In an aspect, UE 700 includes a module 702 for determining that a first portion of a first radio access technology (RAT) activity scheduled during a first time slot overlaps in duration with a second portion of a second RAT activity scheduled during a second time slot. Module 702 may correspond to, for example, a processing system as discussed herein. Further, in an aspect, UE 700 includes a module 704 for excluding the first portion of the first RAT activity based at least in part on determining that the first portion of the first RAT activity overlaps in duration with the second portion of the second RAT activity. Module 704 may correspond to, for example, a processing system as discussed herein. Moreover, in an aspect, UE 700 includes a module 706 for performing a non-overlap portion of the first RAT activity during the first time slot, wherein the non-overlap portion of the first RAT activity is a portion of the first RAT activity that remains after excluding of the first portion of the first RAT activity. Module 706 may correspond to, for example, a processing system as discussed herein.

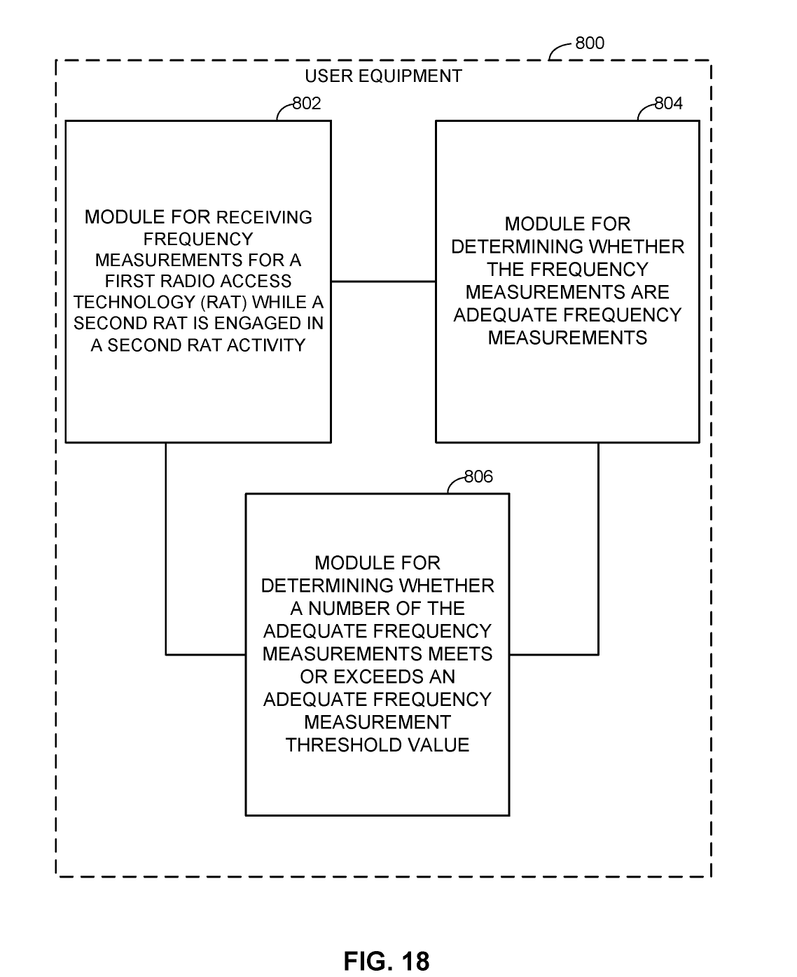

FIG. 18 illustrates an example UE 800 represented as a series of interrelated functional modules, wherein the UE 800 may be the same as or similar to UE 22 (FIG. 1) including measurement management component 50 (FIG. 1). In an aspect, UE 800 includes a module 502 for receiving frequency measurements for a first Radio Access Technology (RAT) while a second RAT is engaged in a second RAT activity. Module 802 may correspond to, for example, a processing system as discussed herein. Further, in an aspect, UE 800 includes a module 804 for determining whether the frequency measurements are adequate frequency measurements. Module 504 may correspond to, for example, a processing system as discussed herein. Moreover, in an aspect, UE 800 includes a module 806 for determining whether a number of the adequate frequency measurements meets or exceeds an adequate frequency measurement threshold value. Module 806 may correspond to, for example, a processing system as discussed herein.

The functionality of the modules of FIGS. 15-18 may be implemented in various ways consistent with the teachings herein. In some aspects, for example, the functionality of these modules may be implemented as one or more electrical components. In some aspects, for example, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module.

In addition, the components and functions represented by FIGS. 15-18 as well as other components and functions described herein, may be implemented using any suitable means. Such means also may be implemented, at least in part, using corresponding structure as taught herein. For example, the components described above in conjunction with the “module” components of FIGS. 15-18 also may correspond to similarly designated “means for” functionality. Thus, in some aspects, one or more of such means may be implemented using one or more of processor components, integrated circuits, or other suitable structure as taught herein.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §212, sixth paragraph, unless the element is expressly recited using the phrase “means for” or, in the case of a method claim, the element is recited using the phrase “step for.”

What is claimed is:

1. A method of interference mitigation at a user equipment during wireless communication, comprising:
determining, at the user equipment, that a first portion of a first radio access technology (RAT) activity scheduled during a first time slot overlaps in duration with a second portion of a second RAT activity scheduled during a second time slot;
excluding, by the user equipment, the first portion of the first RAT activity based at least in part on determining that the first portion of the first RAT activity overlaps in duration with the second portion of the second RAT activity; and
performing, by the user equipment, a non-overlap portion of the first RAT activity during the first time slot, wherein the non-overlap portion of the first RAT activity is a portion of the first RAT activity that remains after excluding of the first portion of the first RAT activity.

2. The method of claim 1, wherein the excluding includes excluding the first portion of the first RAT activity when the overlap in duration meets or exceeds an overlap duration threshold value.

3. The method of claim 1, further comprising determining whether the overlap in duration of the first portion of the first RAT activity occurs at a beginning portion or an end portion of the first time slot.

4. The method of claim 3, further comprising rescheduling the performing when the overlap in duration of the first portion of the first RAT activity occurs at the beginning portion of the first time slot.

5. The method of claim 1, further comprising removing the overlap in duration of the first portion of the first RAT activity when the overlap in duration of the first portion of the first RAT activity occurs at the end portion of the first time slot.

6. The method of claim 1, wherein the first RAT activity includes a frequency measurement during time slot zero.

7. The method of claim 1, further comprising determining one or both of a percentage of overlap or time of overlap associated with the overlap in duration.

8. The method of claim 1, wherein the overlap duration threshold value is either predetermined or automatically adjusted based on one or more network conditions.

9. The method of claim 1, wherein the overlap in duration corresponds to activity scheduled on two or more RATs over the same period of time.

10. The method of claim 1, wherein the first RAT activity corresponds to activity on one or both of a Global System for Mobile Communications (GSM) and Long Term Evolution (LTE).

11. The method of claim 1, wherein the second RAT activity corresponds to activity on a Time Division Synchronous Code Division Multiple Access (TD-SCDMA).

12. The method of claim 1, wherein the first RAT activity corresponds to one or both of a transmission activity and reception activity.

13. The method of claim 1, wherein the second RAT activity corresponds to one or both of a transmission activity and reception activity.

14. A computer-readable medium storing computer executable code for interference mitigation at a user equipment during wireless communication, comprising:
code for determining that a first portion of a first radio access technology (RAT) activity scheduled during a first time slot overlaps in duration with a second portion of a second RAT activity scheduled during a second time slot;
code for excluding the first portion of the first RAT activity based at least in part on determining that the first portion of the first RAT activity overlaps in duration with the second portion of the second RAT activity; and
code for performing a non-overlap portion of the first RAT activity during the first time slot, wherein the non-overlap portion of the first RAT activity is a portion of the first RAT activity that remains after excluding of the first portion of the first RAT activity.

15. The computer-readable medium of claim 14, wherein the code for excluding includes code for excluding the first portion of the first RAT activity when the overlap in duration meets or exceeds an overlap duration threshold value.

16. An apparatus for interference mitigation at a user equipment during wireless communication, comprising:
means for determining that a first portion of a first radio access technology (RAT) activity scheduled during a first time slot overlaps in duration with a second portion of a second RAT activity scheduled during a second time slot;
means for excluding the first portion of the first RAT activity based at least in part on determining that the first portion of the first RAT activity overlaps in duration with the second portion of the second RAT activity; and
means for performing a non-overlap portion of the first RAT activity during the first time slot, wherein the non-overlap portion of the first RAT activity is a portion of the first RAT activity that remains after excluding of the first portion of the first RAT activity.

17. The apparatus of claim 16, wherein the means for excluding includes means for excluding the first portion of the first RAT activity when the overlap in duration meets or exceeds an overlap duration threshold value.

18. An apparatus for interference mitigation at a user equipment during wireless communication, comprising:
an overlap determination component configured to determine that a first portion of a first radio access technology (RAT) activity scheduled during a first time slot overlaps in duration with a second portion of a second RAT activity scheduled during a second time slot;
an excluding component configured to exclude the first portion of the first RAT activity based at least in part on determining that the first portion of the first RAT activity overlaps in duration with the second portion of the second RAT activity; and
a communication component configured to perform a non-overlap portion of the first RAT activity during the first time slot, wherein the non-overlap portion of the first RAT activity is a portion of the first RAT activity that remains after excluding of the first portion of the first RAT activity.

19. The apparatus of claim 18, wherein the excluding includes excluding the first portion of the first RAT activity when the overlap in duration meets or exceeds an overlap duration threshold value.

20. The apparatus of claim 18, further comprising determining whether the overlap in duration of the first portion of the first RAT activity occurs at a beginning portion or an end portion of the first time slot.

21. The apparatus of claim 20, further comprising rescheduling the performing when the overlap in duration of the first portion of the first RAT activity occurs at the beginning portion of the first time slot.

22. The apparatus of claim 18, further comprising removing the overlap in duration of the first portion of the first RAT activity when the overlap in duration of the first portion of the first RAT activity occurs at the end portion of the first time slot.

23. The apparatus of claim 18, wherein the first RAT activity includes a frequency measurement during time slot zero.

24. The apparatus of claim 18, wherein the overlap determination component is further configured to determine one or both of a percentage of overlap or time of overlap associated with the overlap in duration.

25. The apparatus of claim 18, wherein the overlap duration threshold value is either predetermined or automatically adjusted based on one or more network conditions.

26. The apparatus of claim 18, wherein the overlap in duration corresponds to activity scheduled on two or more RATs over the same period of time.

27. The apparatus of claim 18, wherein the first RAT activity corresponds to activity on one or both of a Global System for Mobile Communications (GSM) and Long Term Evolution (LTE).

28. The apparatus of claim 18, wherein the second RAT activity corresponds to activity on a Time Division Synchronous Code Division Multiple Access (TD-SCDMA).

29. The apparatus of claim 18, wherein the first RAT activity corresponds to one or both of a transmission activity and reception activity.

30. The apparatus of claim 18, wherein the second RAT activity corresponds to one or both of a transmission activity and reception activity.
